(19) United States
(12) Patent Application Publication
(10) Pub. No.: US 2026/0020080 A1
(43) Pub. Date: Jan. 15, 2026

(54) TECHNIQUES FOR FREQUENCY RESOURCE ALLOCATION IN RANDOM ACCESS CHANNEL

(71) Applicant: QUALCOMM INCORPORATED, San Diego, CA (US)

(72) Inventors: Hung Dinh Ly, San Diego, CA (US); Yongjun Kwak, San Diego, CA (US); Kexin Xiao, Shanghai (CN)

(21) Appl. No.: 18/994,359

(22) PCT Filed: Aug. 31, 2022
(86) PCT No.: PCT/CN2022/116029

§ 371 Date: Jan. 14, 2025

(51) Int. Cl. H04W 74/08; H04W 74/0833

(52) U.S. Cl. CPC H04W 74/0866; H04W 74/0833

(57) ABSTRACT

Methods, systems, and devices for method for wireless communication are described. A user equipment (UE) may receive, from a network entity, an indication of an uplink bandwidth part associated with a random access procedure, and the uplink bandwidth part may include a plurality of subbands corresponding to a set of random access occasions. The UE may select a random access occasion from the set of random access occasions based on an offset parameter, and the UE may transmit an uplink random access channel message at the random access occasion of the set of random access occasions.

### CROSS REFERENCE

The present Application is a 371 national stage filing of International PCT Application No. PCT/CN2022/116029 by Ly et al. entitled “TECHNIQUES FOR FREQUENCY RESOURCE ALLOCATION IN RANDOM ACCESS CHANNEL,” filed Aug. 31, 2022, which is assigned to the assignee hereof, and which is expressly incorporated by reference in its entirety herein.

### FIELD OF TECHNOLOGY

The following relates to method for wireless communication, including techniques for frequency resource allocation in random access channel.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications networks, a network entity and a user equipment (UE) may communicate using a random access channel (RACH) procedure, which may include the UE using RACH occasions (ROs) and subbands of a bandwidth part to perform transmissions. In some examples, however, the UE may operate on lower frequency bands, and the UE may be unable to define a frequency domain resource allocation to map the ROs and subbands for transmissions.

### SUMMARY

The described techniques relate to improved methods, systems, devices, and apparatuses that support techniques for frequency resource allocation in random access channel. Generally, the described techniques provide for a user equipment (UE) to perform a random access channel (RACH) procedure by mapping RACH occasions (ROs) to a set of subbands based on a frequency resource allocation. For example, the UE, the network entity, or both may define multiple frequency offsets for partitioning an uplink bandwidth part into subbands. For example, the UE may determine to map a physical RACH (PRACH) transmission (e.g., msg1) to an RO in the uplink bandwidth part. Additionally, or alternatively, the UE may determine to map a physical uplink shared channel (PUSCH) transmission (e.g., msg3) to a subband overlapping with the selected RO. The UE may use the subband to transmit the PUSCH transmission to the network entity. Additionally, or alternatively, the network entity may transmit a mapping of the ROs and the subbands to the UE. In some examples, if the UE performs multiple RACH transmissions, the UE may determine the subband for the PUSCH transmission based one or more of the ROs used for the last RACH transmission. Additionally, or alternatively, the network entity may transmit a physical downlink shared channel (PDSCH) transmission to the UE, and the UE may transmit a physical uplink control channel (PUCCH) transmission with hybrid automatic repeat request-acknowledgement (HARQ-ACK) feedback to the network entity using the subband previously used for the PUSCH transmission.

A method for wireless communication at a UE is described. The method may include receiving an indication of an uplink bandwidth part associated with a random access procedure, the uplink bandwidth part including a set of multiple subbands corresponding to a set of multiple ROs, selecting an RO from the set of multiple ROs based on an offset parameter, and transmitting a PUSCH message at the RO of the set of multiple ROs.

An apparatus for wireless communication at a UE is described. The apparatus may include a processor, memory coupled with the processor, and instructions stored in the memory. The instructions may be executable by the processor to cause the apparatus to receive an indication of an uplink bandwidth part associated with a random access procedure, the uplink bandwidth part including a set of multiple subbands corresponding to a set of multiple ROs, select a RO from the set of multiple ROs based on an offset parameter, and transmit an uplink RACH message at the RO of the set of multiple ROs.

Another apparatus for wireless communication at a UE is described. The apparatus may include means for receiving an indication of an uplink bandwidth part associated with a random access procedure, the uplink bandwidth part including a set of multiple subbands corresponding to a set of multiple ROs, means for selecting a RO from the set of multiple ROs based on an offset parameter, and means for transmitting an uplink RACH message at the RO of the set of multiple ROs.

A non-transitory computer-readable medium storing code for wireless communication at a UE is described. The code may include instructions executable by a processor to receive an indication of an uplink bandwidth part associated with a random access procedure, the uplink bandwidth part including a set of multiple subbands corresponding to a set of multiple ROs, select a RO from the set of multiple ROs based on an offset parameter, and transmit an uplink RACH message at the RO of the set of multiple ROs.

Some examples of the method, apparatuses, and non-transitory computer-readable medium described herein may further include operations, features, means, or instructions for receiving a system information message including the offset parameter and determining the offset parameter based on receiving the system information message.

Some examples of the method, apparatuses, and non-transitory computer-readable medium described herein may further include operations, features, means, or instructions for identifying a subband of the set of multiple subbands overlapping in frequency with the RO of the set of multiple ROs and transmitting an initial subset of a physical uplink shared channel in a first resource block of the subband of the set of multiple subbands.

Some examples of the method, apparatuses, and non-transitory computer-readable medium described herein may further include operations, features, means, or instructions for transmitting a second uplink RACH message in a subband of the set of multiple subbands overlapping in frequency with the RO of the set of multiple ROs, where the uplink RACH message includes a physical RACH preamble and the second uplink RACH message includes a PUSCH.

In some examples of the method, apparatuses, and non-transitory computer-readable medium described herein, transmitting the second uplink RACH message in the subband of the set of multiple subbands may include operations, features, means, or instructions for receiving, from a network entity, a mapping between the set of multiple ROs and the set of multiple subbands and selecting the subband of the set of multiple subbands for transmitting the second uplink RACH message based on the mapping.

In some examples of the method, apparatuses, and non-transitory computer-readable medium described herein, the mapping includes at least one of a one to one mapping between the set of multiple ROs and the set of multiple subbands, a mapping between the RO of the set of multiple ROs and the set of multiple subbands, a mapping between the subband of the set of multiple subbands and the set of multiple ROs, or a combination thereof.

In some examples of the method, apparatuses, and non-transitory computer-readable medium described herein, transmitting the uplink RACH message may include operations, features, means, or instructions for transmitting one or more uplink random access preambles at one or more ROs of the set of multiple ROs, where each of the one or more uplink random access message instances corresponding to a first message of the random access procedure may be transmitted on a different RO, where the same preamble may be repeated in each random access message instance.

In some examples of the method, apparatuses, and non-transitory computer-readable medium described herein, the one or more ROs of the set of multiple ROs may be different in time, frequency, or a combination thereof.

Some examples of the method, apparatuses, and non-transitory computer-readable medium described herein may further include operations, features, means, or instructions for transmitting a PUSCH message in a subband of the set of multiple subbands overlapping in frequency with the RO of the one or more ROs, where the RO includes the RO at which a last uplink random access message instance of the one or more uplink random access message instances was transmitted, where the one or more uplink random access message instances correspond to a first message of the random access procedure.

Some examples of the method, apparatuses, and non-transitory computer-readable medium described herein may further include operations, features, means, or instructions for transmitting a PUSCH message in a subband of the set of multiple subbands overlapping in frequency with the RO of the one or more ROs, where the RO includes the RO at which a first uplink random access message instance corresponding to the first message of the random access procedure was transmitted.

Some examples of the method, apparatuses, and non-transitory computer-readable medium described herein may further include operations, features, means, or instructions for transmitting a second uplink RACH message in a subband of the set of multiple subbands overlapping in frequency with the RO of the set of multiple ROs, where the uplink RACH message includes a physical RACH preamble and the second uplink random access channel message includes a physical uplink control channel.

In some examples of the method, apparatuses, and non-transitory computer-readable medium described herein, the offset parameter indicates at least one of a same offset for each subband of the set of multiple subbands, a different offset for each subband of the set of multiple subbands, or a combination thereof.

In some examples of the method, apparatuses, and non-transitory computer-readable medium described herein, the offset parameter may be based on at least one of a maximum bandwidth of the UE, an initial physical resource block of the uplink bandwidth part, a sub-carrier spacing of the uplink bandwidth part, or a combination thereof.

In some examples of the method, apparatuses, and non-transitory computer-readable medium described herein, a subband of the set of multiple subbands includes a predefined number of resource blocks.

A method for wireless communication at a network entity is described. The method may include transmitting, to a UE, an indication of an uplink bandwidth part associated with a random access procedure, the uplink bandwidth part including a set of multiple subbands corresponding to a set of multiple ROs and receiving an uplink random access channel message at a RO of the set of multiple ROs, where the RO of the set of multiple ROs based on an offset parameter.

An apparatus for wireless communication at a network entity is described. The apparatus may include a processor, memory coupled with the processor, and instructions stored in the memory. The instructions may be executable by the processor to cause the apparatus to transmit, to a UE, an indication of an uplink bandwidth part associated with a random access procedure, the uplink bandwidth part including a set of multiple subbands corresponding to a set of multiple ROs and receive an uplink random access channel message at a RO of the set of multiple ROs, where the RO of the set of multiple ROs based on an offset parameter.

Another apparatus for wireless communication at a network entity is described. The apparatus may include means for transmitting, to a UE, an indication of an uplink bandwidth part associated with a random access procedure, the uplink bandwidth part including a set of multiple subbands corresponding to a set of multiple ROs and means for receiving an uplink random access channel message at a RO of the set of multiple ROs, where the RO of the set of multiple ROs based on an offset parameter.

A non-transitory computer-readable medium storing code for wireless communication at a network entity is described. The code may include instructions executable by a processor to transmit, to a UE, an indication of an uplink bandwidth part associated with a random access procedure, the uplink bandwidth part including a set of multiple subbands corresponding to a set of multiple ROs and receive an uplink random access channel message at a RO of the set of multiple ROs, where the RO of the set of multiple ROs based on an offset parameter.

Some examples of the method, apparatuses, and non-transitory computer-readable medium described herein may further include operations, features, means, or instructions for transmitting, to the UE, a system information message including the offset parameter.

Some examples of the method, apparatuses, and non-transitory computer-readable medium described herein may further include operations, features, means, or instructions for identifying a subband of the set of multiple subbands overlapping in frequency with the RO of the set of multiple ROs and receiving an initial subset of a PUSCH channel in a first resource block of the subband of the set of multiple subbands.

Some examples of the method, apparatuses, and non-transitory computer-readable medium described herein may further include operations, features, means, or instructions for receiving a second uplink random access channel message in a subband of the set of multiple subbands overlapping in frequency with the RO of the set of multiple ROs, where the uplink random access channel message includes a physical random access channel preamble and the second uplink random access channel message includes a physical uplink shared channel.

In some examples of the method, apparatuses, and non-transitory computer-readable medium described herein, receiving the second uplink random access channel message in the subband of the set of multiple subbands may include operations, features, means, or instructions for transmitting, to the UE, a mapping between the set of multiple ROs and the set of multiple subbands, where the subband of the set of multiple subbands for transmitting the second uplink random access channel message may be selected based on the mapping.

In some examples of the method, apparatuses, and non-transitory computer-readable medium described herein, the mapping includes at least one of a one to one mapping between the set of multiple ROs and the set of multiple subbands, a mapping between the RO of the set of multiple ROs and the set of multiple subbands, a mapping between the subband of the set of multiple subbands and the set of multiple ROs, or a combination thereof.

In some examples of the method, apparatuses, and non-transitory computer-readable medium described herein, receiving the uplink random access channel message may include operations, features, means, or instructions for receiving one or more uplink random access preambles at one or more ROs of the set of multiple ROs, where each of the one or more uplink random access message instances corresponding to a first message of the random access procedure may be transmitted on a different RO, where the same preamble may be repeated in each random access message instance.

In some examples of the method, apparatuses, and non-transitory computer-readable medium described herein, the one or more ROs of the set of multiple ROs may be different in time, frequency, or a combination thereof.

Some examples of the method, apparatuses, and non-transitory computer-readable medium described herein may further include operations, features, means, or instructions for receiving a physical uplink shared message in a subband of the set of multiple subbands overlapping in frequency with the RO of the one or more ROs, where the RO includes the RO at which a last uplink random access message instance of the one or more uplink random access instances was received, where the one or more uplink random access message instances correspond to a first message of the random access procedure.

Some examples of the method, apparatuses, and non-transitory computer-readable medium described herein may further include operations, features, means, or instructions for receiving a physical uplink shared message in a subband of the set of multiple subbands overlapping in frequency with the RO of the one or more ROs, where the RO includes the RO at which a first uplink random access message instance corresponding to the first message of the random access procedure was transmitted.

Some examples of the method, apparatuses, and non-transitory computer-readable medium described herein may further include operations, features, means, or instructions for receiving a second uplink random access channel message in a subband of the set of multiple subbands overlapping in frequency with the RO of the set of multiple ROs, where the uplink random access channel message includes a physical random access channel preamble and the second uplink random access channel message includes a physical uplink control channel.

In some examples of the method, apparatuses, and non-transitory computer-readable medium described herein, the offset parameter indicates at least one of a same offset for each subband of the set of multiple subbands, a different offset for each subband of the set of multiple subbands, or a combination thereof.

In some examples of the method, apparatuses, and non-transitory computer-readable medium described herein, the offset parameter may be based on at least one of a maximum bandwidth of the UE, an initial physical resource block of the uplink bandwidth part, a sub-carrier spacing of the uplink bandwidth part, or a combination thereof.

In some examples of the method, apparatuses, and non-transitory computer-readable medium described herein, a subband of the set of multiple subbands includes a predefined number of resource blocks.

### BRIEF DESCRIPTION OF THE DRAWINGS

FIG. 1 illustrates an example of a wireless communications system that supports techniques for frequency resource allocation in random access channel (RACH) in accordance with one or more aspects of the present disclosure.

FIG. 2 illustrates an example of a wireless communications system that supports techniques for frequency resource allocation in RACH in accordance with one or more aspects of the present disclosure.

FIG. 3 illustrates an example of a frequency resource allocation scheme that supports techniques for frequency resource allocation in RACH in accordance with one or more aspects of the present disclosure.

FIG. 4 illustrates an example of a frequency resource allocation scheme that supports techniques for frequency resource allocation in RACH in accordance with one or more aspects of the present disclosure.

FIGS. 5A and 5B illustrate examples of a frequency mapping scheme that supports techniques for frequency resource allocation in RACH in accordance with one or more aspects of the present disclosure.

FIG. 6 illustrates an example of a frequency resource allocation scheme that supports techniques for frequency resource allocation in RACH in accordance with one or more aspects of the present disclosure.

FIG. 7 illustrates an example of a process flow that supports techniques for frequency resource allocation in RACH in accordance with one or more aspects of the present disclosure.

FIGS. 8 and 9 show block diagrams of devices that support techniques for frequency resource allocation in RACH in accordance with one or more aspects of the present disclosure.

FIG. 10 shows a block diagram of a communications manager that supports techniques for frequency resource allocation in RACH in accordance with one or more aspects of the present disclosure.

FIG. 11 shows a diagram of a system including a device that supports techniques for frequency resource allocation in RACH in accordance with one or more aspects of the present disclosure.

FIGS. 12 and 13 show block diagrams of devices that support techniques for frequency resource allocation in RACH in accordance with one or more aspects of the present disclosure.

FIG. 14 shows a block diagram of a communications manager that supports techniques for frequency resource allocation in RACH in accordance with one or more aspects of the present disclosure.

FIG. 15 shows a diagram of a system including a device that supports techniques for frequency resource allocation in RACH in accordance with one or more aspects of the present disclosure.

FIGS. 16 through 19 show flowcharts illustrating methods that support techniques for frequency resource allocation in RACH in accordance with one or more aspects of the present disclosure.

### DETAILED DESCRIPTION

In some wireless communications networks, a network entity and a user equipment (UE) may communicate using a random access channel (RACH) procedure (e.g., a two-step RACH procedure, a four-step RACH procedure, etc.). The RACH procedure may include uplink messages and downlink messages, where the messages may be transmitted on a UE-specific bandwidth range. In some examples, the network entity, the UE, or both may define an initial uplink bandwidth part for frequency resource allocation of the messages. A UE may transmit each message (e.g., msg1, msg3, or both) using a bandwidth part of the uplink bandwidth part based on sub-carrier spacing, and each bandwidth part may be associated with multiple RACH occasions (ROs). For example, the UE may determine to map a physical RACH (PRACH) transmission (e.g., msg1) to an RO based on the frequency resource allocation. In some examples, the UE may use a subband that overlaps in frequency with the selected RO to transmit another message (e.g., msg3) of the RACH procedure. However, some UEs (e.g., eRedcap (enhanced reduced capability) UEs) may operate on a limited frequency range (e.g., 5 MHz), and the UE may be unable to define a frequency resource allocation for the messages within the limited frequency range, which may result in increased latency and inefficient communications.

The features described herein generally relate to a UE (e.g., an eRedcap UE) mapping ROs to a set of subbands based on a frequency resource allocation. For example, the UE, the network entity, or both may define multiple frequency offsets for partitioning an uplink bandwidth part into subbands. Each subband may include a predefined quantity of resource blocks (RBs), and each subband may overlap in frequency with a quantity of ROs. For example, the UE may determine to map a physical RACH (PRACH) transmission (e.g., msg1) to an RO in the uplink bandwidth part. The UE may use the RO to transmit the PRACH transmission to the network entity as part of the RACH procedure. Additionally, or alternatively, the UE may determine to map a physical uplink shared channel (PUSCH) transmission (e.g., msg3) to a subband overlapping with the selected RO. The UE may use the subband to transmit the PUSCH transmission to the network entity as part of the RACH procedure. Additionally, or alternatively, the network entity may transmit a mapping of the ROs and the subbands to the UE. In this example, the UE may determine an RO and a subband for the PRACH and PUSCH transmissions based on the configured mapping. Additionally, or alternatively, if the UE performs multiple RACH transmissions, the UE may determine the subband for the PUSCH transmission based one or more of the ROs used for the last RACH transmission. Additionally, or alternatively, the network entity may transmit a physical downlink shared channel (PDSCH) transmission to the UE. The UE may transmit a physical uplink control channel (PUCCH) transmission to the network entity using the subband previously used for the PUSCH transmission, and the PUCCH transmission may include hybrid automatic repeat request-acknowledgement (HARQ-ACK) feedback.

Aspects of the disclosure are initially described in the context of wireless communications systems. Aspects of the disclosure are further illustrated and described by frequency resource allocation schemes, frequency mapping schemes, and a process flow. Aspects of the disclosure are further illustrated by and described with reference to apparatus diagrams, system diagrams, and flowcharts that relate to techniques for frequency resource allocation in RACH.

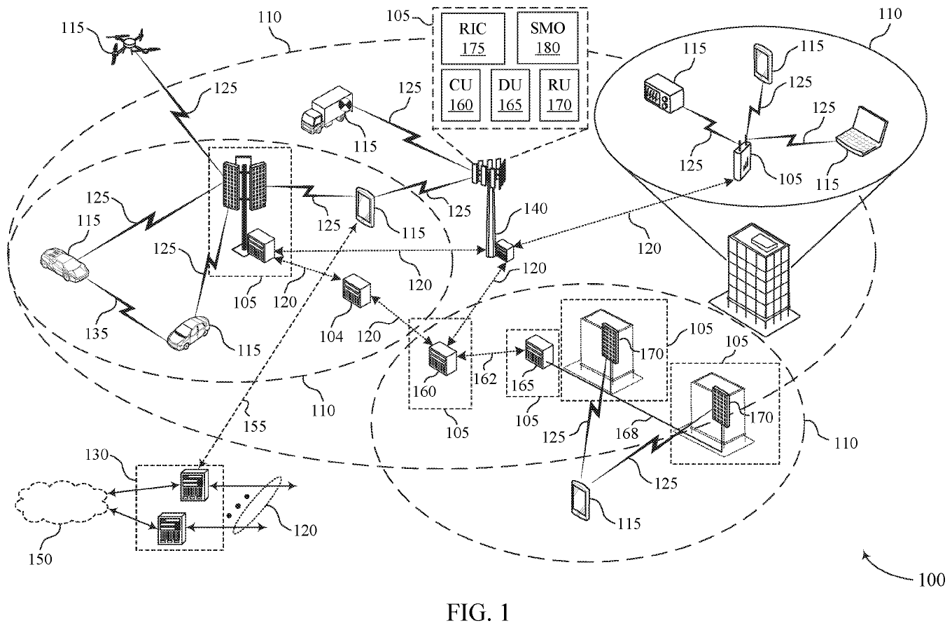

FIG. 1 illustrates an example of a wireless communications system 100 that supports techniques for frequency resource allocation in RACH in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for frequency resource allocation in RACH as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may be configured to support techniques for frequency resource allocation to perform RACH procedure. Devices in the wireless communications system 100, such as UEs 115 may perform the RACH procedure. In some examples, IoT devices, such as UEs, may be associated with enhanced mobile broadband (eMBB) communications and ultra-reliability and low latency communication (URLLC) with other IoT 5G devices. For example, a UE 115 may perform communications in eMBB with a minimum level of data transfer rate, which may be associated with increased bandwidth and decreased latency in 5G wireless networks. In some examples, UEs 115, such as RedCap (e.g., reduced capability) UEs, may be associated with NR-light (e.g., reduced capability NR device) communications. RedCap UEs may support lower latency communications in eMBB communication or millimeter wave (mmW) communications in a low-power wide-area (LPWA) network. MmW communications (e.g., a band of frequency spectrum between 30 GHz and 300 GHz) in an LPWA network may be associated with efficient long-range communications between 5G devices. For example, RedCap devices may operate within the mmW frequency range in the LPWA network, the RedCap devices may include logistic trackers, wearables, video surveillance devices, health monitors, smartphones, industrial wireless sensors, or the like. In some examples, UEs 115, such as eRedCap (enhanced RedCap) UEs, may be associated with one or more of NR-Superlight communications. NR-Superlight communications may include LTE enhanced machine-type communication (eMTC), narrowband (NB)-IoT communications (e.g., narrowband may be associated with LPWA communications), or massive IoT. eMTC may be a type of LPWA communications technology, which may support communications between IoT devices with relatively low device complexity and extended wireless range. For example, ERedCap devices may include asset trackers, wearables, utility meters, agriculture sensors, parking sensors, industrial sensors, and the like. Massive IoT may include communications with a relatively large quantity (e.g., billions) of connected devices, which may include RedCap UEs, eRedCap UEs, and other UEs 115.

In some examples, eRedCap UEs may operate in a relatively smaller frequency range (e.g., 5 MHZ) than RedCap UEs (e.g., 20 MHZ) and other devices used for eMBB communications. In some examples, eRedCap UEs may support half duplex (HD), full duplex (FD)-frequency division duplexing (FDD), or time division duplex (TDD) duplexing of subbands within bandwidth part for transmissions. In some examples, eRedCap UEs may have one antenna for reception and transmission, one MIMO layer for uplink transmissions, and one MIMO layer for downlink receptions. In some examples, eRedCap UEs may use up to 3 Mbps (e.g., megabits per second) (e.g., peak data rate) for uplink and downlink communications, and the communications may be associated with a 164 dB maximum coupling loss (e.g., device attenuation/interference). In some examples, eRedCap UEs may use polar channel coding, rate matching coding, low density parity check (LDPC) data coding, 64 quadrature amplitude modulation (QAM) for downlink reception, and 16 QAM for uplink transmission. Additionally, or alternatively, eRedCap UEs may be configured with enhancements for wake-up signals, extended discontinuous reception (eDRX), positioning within a wireless range, early data transmissions, and preconfigured uplink resources.

In some examples, eRedCap UEs may perform a two-step RACH procedure or a four-step RACH procedure. In the example of a two-step RACH procedure, the network entity 105 may transmit a message (e.g., a synchronization signal block (SSB), system information block (SIB), a reference signal, RRC signaling, etc.) to a connected UE 115. An SSB may correspond to a beam at the UE 115 to perform an uplink transmission. The UE 115 may perform downlink synchronization, system information decoding and measurement, or both to transmit a message to the network entity 105. The message from the UE 115 may include a preamble (e.g., a msgA preamble) and a payload (e.g., a msgA payload). The msgA preamble may include a PRACH information block and a guard time (e.g., buffer time) block. The message may include a transmissions gap time (e.g., TxG) between the msgA preamble and the msgA payload. The msgA payload may include a demodulation reference signal (DMRS) transmission block or a PUSCH transmission block, and a guard time (e.g., buffer time) block. In some examples, a sub-band of the msgA preamble and a sub-band of the msgA payload may be a same sub-band. In some examples, the sub-band of the msgA preamble may be a different sub-band than the sub-band of the msgA payload. The network entity 105 may process the msgA preamble and the msgA payload, and, in some examples, the network entity 105 may transmit a physical downlink control channel (PDCCH) (e.g., msgB PDCCH) and a physical downlink shared channel (PDSCH) (e.g., msgB PDSCH) to the UE 115. In some examples, the UE 115 may transmit a PUSCH with HARQ ACK feedback to the network entity 105 in response to the PDCCH and PDSCH. In some examples, the sub-band of the msgB may be based on msgA.

In some examples, a four-step RACH procedure may include the UE 115 transmitting a physical RACH (PRACH) preamble (e.g., msg1) to the network entity 105. The network entity 105 may transmit a PDCCH, a PDSCH, or both (e.g., as multiple random access responses (RAR)) as part of msg2. The msg2 may include one or more of a timing advance for the UE 115, an uplink grant for another RACH transmission (e.g., msg3), or a temporary cell radio network temporary identifier (TC-RNTI). In response to msg2, the UE 115 may transmit a PUSCH transmission (e.g., msg3) to the network entity 105, and the msg3 may include one or more of an RRC connection request, a scheduling request, or a buffer status. The network entity 105 may transmit a PDCCH or PDSCH (e.g., msg4) to the UE 115, and the msg4 may include a contention resolution message. In some examples, the UE 115 may transmit a PUCCH to the network entity 105 in response to msg4.

In some examples, eRedCap UEs may perform RACH (e.g., NR RACH) procedures with multiple RACH preamble formats, which may include a cyclic prefix (CP) and multiple sequences of data. In such examples, long sequence-based formats may be associated with a maximum bandwidth of 5 MHZ, a bandwidth of the PRACH preamble (e.g., 5 MHZ). In another example, the PRACH preamble may include a short sequence of data, and the subcarrier spacing of the bandwidth may be 15 kHz. In this example, the bandwidth may be less than 5 MHZ (e.g., 4.32 kHz) for a relatively greater subcarrier spacing (e.g., 30 kHz) in the PRACH (e.g., NR frequency 1 (FR1) PRACH) preamble formats.

In some examples, the network entity 105 may configure an eRedCap UE with an initial uplink bandwidth part in a SIB (e.g., SIB1) include in first message (e.g., msg1) of the RACH procedure. The initial uplink bandwidth part may be based on sub-carrier spacing, and the bandwidth part may be associated with multiple RACH occasions (ROs) for RACH message transmissions. Each message of the RACH procedure transmitted by the UE 115 may be included within the frequency domain of the bandwidth part. In some examples, the network entity 105 may configure the UE 115 with a first RO frequency allocation with an offset from an initial physical resource block (e.g., PRB0) of the bandwidth part (e.g., msg1-FrequencyStart) for the UE 115 to transmit msg1 of the RACH procedure. For example, the UE 115 may determine to map the PRACH transmission (e.g., msg1) to an RO based on the frequency resource allocation (e.g., PRB0). In some examples, the UE 115 may use a subband that overlaps in frequency with the selected RO to transmit a PUSCH transmission (e.g., msg3) of the RACH procedure. In this example, the UE 115 may map the PUSCH transmission to resources based on the PRB0. However, since eRedCap UEs may operate on a limited frequency range (e.g., 5 MHZ), the UE 115 may have a limited quantity of ROs within the bandwidth part (e.g., one or two ROs based on the PRACH transmission subcarrier spacing), and the UE 115 may be unable to define a frequency resource allocation for the messages within the limited frequency range. Additionally, or alternatively, the eRedCap UE may be unable to communicate with Redcap UEs and other regular UEs 115 because of the limited bandwidth, which may result in increased latency and inefficient communications.

In order to decrease latency and to allow the eRedCap UE to efficiently perform the RACH procedure, the described techniques provide for a UE 115 (e.g., an eRedCap UE) to map ROs to a set of subbands based on a frequency resource allocation. For example, the UE 115, the network entity 105, or both may define multiple frequency offsets for partitioning an uplink bandwidth part into subbands. Each subband may include a predefined quantity of resource blocks (RBs), and each subband may overlap in frequency with a quantity of ROs. For example, the UE 115 may determine to map the PRACH transmission (e.g., msg1) to an RO in the bandwidth part. The UE 115 may use the RO to transmit the PRACH transmission to the network entity 105 as part of the RACH procedure. Additionally, or alternatively, the UE 115 may determine to map a PUSCH transmission (e.g., msg3) to a subband overlapping with the selected RO. The UE 115 may use the subband to transmit the PUSCH transmission to the network entity 105 as part of the RACH procedure. Additionally, or alternatively, the network entity 105 may transmit a mapping of the ROs and the subbands to the UE 115. In this example, the UE 115 may determine an RO and a subband for the PRACH and PUSCH transmissions based on the configured mapping. Additionally, or alternatively, if the UE 115 performs multiple RACH transmissions, the UE 115 may determine the subband for the PUSCH transmission based one or more of the ROs used for the last RACH transmission. Additionally, or alternatively, the network entity 105 may transmit a PDSCH to the UE 115. The UE 115 may transmit a PUCCH to the network entity 105 using the subband previously used for the PUSCH transmission, and the PUCCH transmission may include HARQ-ACK feedback.

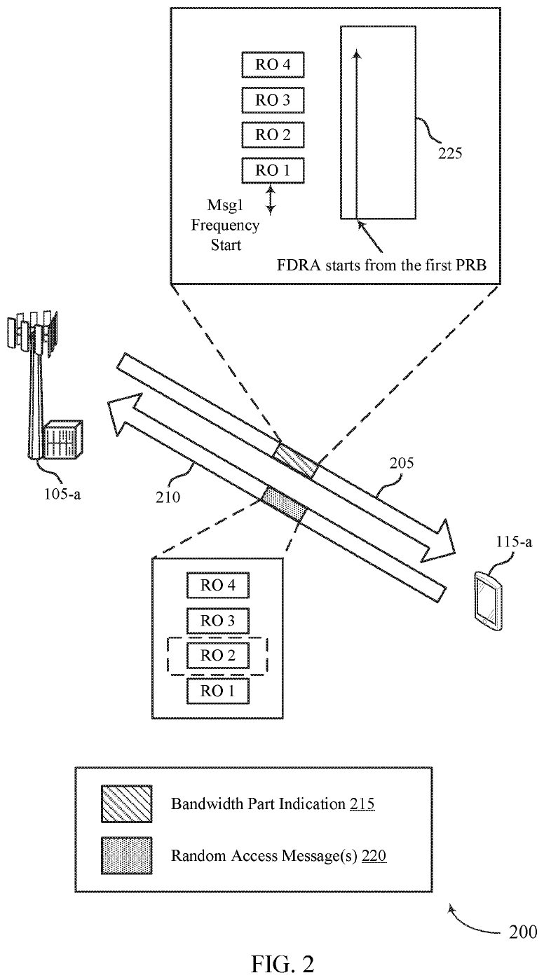

FIG. 2 illustrates an example of a wireless communications system 200 that supports techniques for frequency resource allocation in RACH in accordance with one or more aspects of the present disclosure. In some examples, wireless communications system 200 may implement aspects of wireless communications system 100. For example, wireless communications system 200 may support communications between a network entity 105-a and UE 115-a, which may be examples of corresponding network entities 105 and UEs 115 as described with reference to FIG. 1. In some examples, network entity 105-a may communicate with one or more UEs 115 within a geographic coverage area.

The UE 115-a may send transmissions to the network entity 105-a via uplink communications link 210, and the network entity 105-a may send transmissions to the UE 115-a via downlink communications link 205. For example, the UE 115-a may be an eRedCap UE (as described with reference to FIG. 1), and the network entity 105-a may transmit a bandwidth part indication to the UE 115-a via the downlink communications link 205 for the UE 115-a to perform a RACH procedure. The UE 115-a may perform the RACH procedure by transmitting one or more random access messages 220 via the uplink communications link 210. The bandwidth part indication 215 may indicate a bandwidth part 225, and the bandwidth part 225 may include multiple ROs (e.g., RO 1, RO 2, RO 3, and RO 4). In some examples, the network entity 105-a may configure the UE 115 with a first RO frequency allocation with an offset from PRB0 (e.g., the frequency domain resource allocation (FDRA) may start at a first PRB) of the bandwidth part 225. The UE 115-a may use the first RO frequency allocation to transmit a first message of the RACH procedure (e.g., msg1).

In some examples, the UE 115-a may select a random access occasion from a set of ROs based on an offset parameter. For example, the UE 115-a may define multiple frequency offsets for partitioning the bandwidth part 225 into subbands. The one or more offsets may be based on the PRB0 and the subcarrier spacing of the bandwidth part 225. In some examples, the network entity 105-a may transmit system information to the UE 115-a, and the system information may include an indication of the one or more offsets. The UE 115—may determine to map the PRACH transmission (e.g., msg1) to an RO based on the frequency resource allocation (e.g., PRB0), such that the beginning of the frequency resource allocation for msg1 may be associated with the PRB0. In some examples, the UE 115-a may transmit a first random access message 220 (e.g., msg1) using an RO (e.g., RO 2). Additionally, or alternatively, the UE 115-a may determine to transmit a second random access message 220 (e.g., msg3) to the network entity 105-a using a subband. The subband may overlap in frequency with the selected RO (e.g., RO 2). In some examples, the sub-band for the payload of MsgA (e.g., PUSCH) may be same as the one of the MsgA preamble. In some examples, the sub-band for the payload of MsgA (e.g., PUSCH) may be different from the one of the MsgA preamble and based on a mapping. Additionally, alternatively, the sub-band for MsgB feedback (e.g., ACK) may also depend on MsgA.

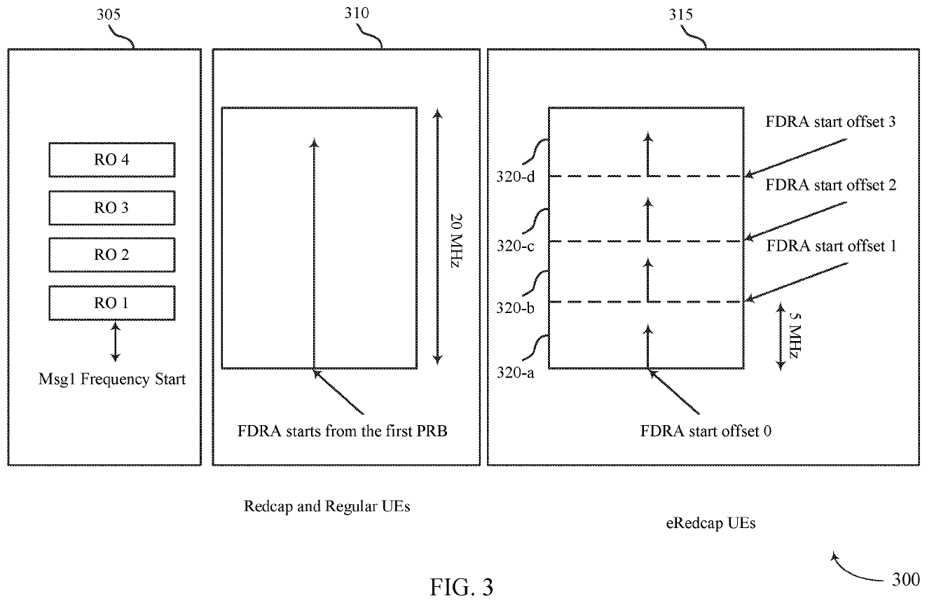

FIG. 3 illustrates an example of a frequency resource allocation scheme 300 that supports techniques for frequency resource allocation in RACH in accordance with one or more aspects of the present disclosure. In some examples, the frequency resource allocation scheme 300 may implement aspects of wireless communications system 100 and wireless communications system 200. For example, the frequency resource allocation scheme 300 may illustrate aspects of techniques performed by a network entity 105 and a UE 115, which may be examples of network entities 105 and UEs 115 as described with reference to FIGS. 1 and 2. For example, the network entity 105 may transmit a bandwidth part indication of a bandwidth part 315 to the UE 115, and the UE 115 may determine a frequency resource allocation for transmission based on the bandwidth part indication.

For example, UEs 115, such as RedCap UEs and other UEs 115 may be configured with a relatively larger bandwidth part 310 (e.g., 20 MHz) than a bandwidth part allocated to eRedCap UEs (e.g., 5 MHz). In some examples, eRedCap UEs may receive an indication of the bandwidth part 315, and the bandwidth part 315 may be associated with multiple ROs 305 (e.g., RO 1, RO 2, RO 3, and RO 4). The UE 115 (e.g., an eRedCap UE) may define multiple frequency offsets (e.g., FDRA start offset 0, FDRA start offset 1, FDRA start offset 2, and FDRA start offset 3) within the bandwidth part 315. The UE 115 may use the multiple frequency offsets to partition the bandwidth part 315 into subbands 320 (e.g., subbands spanning 5 MHz), and the subbands 320 may overlap in frequency with the ROs. A subband 320 may include a predefined number of resource blocks (RBs) N_{rb}. The subband 320 may be considered valid if the subband 320 includes the predefined number of RBs.

In some examples, the frequency offsets may be based on an initial PRB (e.g., PRB0) and a subcarrier spacing of the bandwidth part 315. In some examples, the network entity 105 may configure the UE 115 with the frequency offsets. Additionally, or alternatively, the frequency offsets may be based on a maximum UE bandwidth. For example, the offset k may be equal to a product of the offset and a number of RBs N_{rb} included in the maximum UE bandwidth (e.g., k=k*N_{rb}). The UE 115 may select an RO to perform a transmission for the RACH procedure. For example, the UE 115 may select RO 2 to transmit msg1 of the RACH procedure, and the msg1 may be associated with a frequency width start of the bandwidth part 315. Additionally, or alternatively, the UE 115 may select a subband (e.g., subband 320-b) that overlaps with the selected RO (e.g., RO 2) to transmit msg3 of the RACH procedure. Msg3 may be associated with a frequency width start of the bandwidth part 315, and the frequency width start may be the first RB of a valid subband 320.

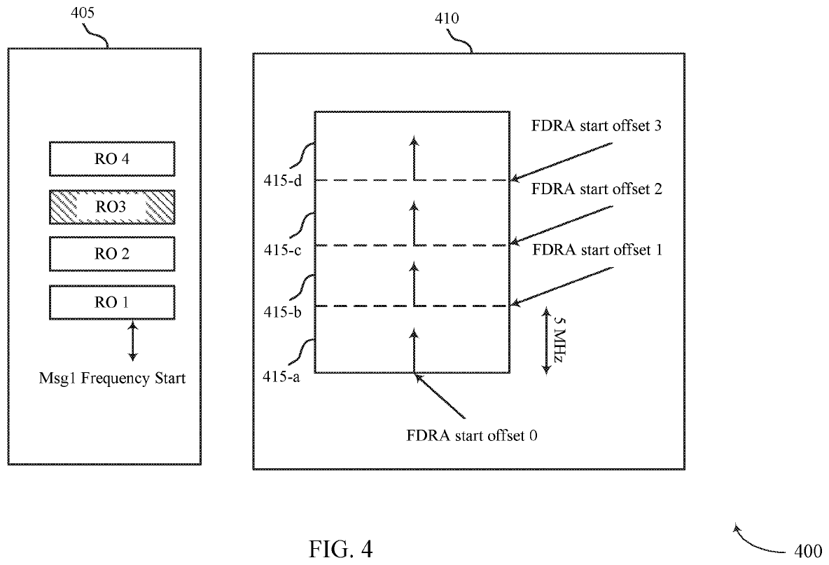

FIG. 4 illustrates an example of a frequency resource allocation scheme 400 that supports techniques for frequency resource allocation in RACH in accordance with one or more aspects of the present disclosure. In some examples, the frequency resource allocation scheme 400 may implement aspects of wireless communications system 100 wireless communications system 200, and frequency resource allocation scheme 300. For example, the frequency resource allocation scheme 300 may illustrate aspects of techniques performed by a network entity 105 and a UE 115, which may be examples of network entities 105 and UEs 115 as described with reference to FIGS. 1 through 3. For example, the network entity 105 may transmit a bandwidth part indication of a bandwidth part 410 to the UE 115, and the UE 115 may determine a frequency resource allocation for transmission based on the bandwidth part indication.

In some examples, the UE 115 may select an RO (e.g., RO 3) of multiple ROs 405 to transmit msg1 (e.g., a PRACH transmission) of the RACH procedure to a network entity 105. Additionally, or alternatively, the UE 115 may determine a subband 415 to transmit msg3 (e.g., a PUSCH transmission) of the RACH procedure. The subband (e.g., subband 415-c) may fully overlap in frequency (e.g., frequency domain) with the selected RO (e.g., RO 3). Additionally, or alternatively, the network entity 105 may configure a mapping between the RO (e.g., RO 3) and the subband (e.g., subband 415-c). For example, the network entity 105 may transmit a mapping to the UE 115. The mapping may be one or more of a one to one mapping between the ROs 405 and the subbands 415, a mapping between the selected RO (e.g., RO 3) and the multiple subbands 415, or a mapping between the selected subband (e.g., subband 415-c) and the ROs 405. The UE 115 may use the mapping and the selected RO (e.g., RO 3) to transmit msg3 to the network entity 105 on the selected subband 415. The network entity 105 may transmit msg4 of the RACH procedure in response to receiving msg3.

Additionally, or alternatively, in response to receiving msg4 (e.g., PDSCH transmission), the UE 115 may transmit a PUCCH to the network entity 105. The PUCCH may include a HARQ-ACK feedback, and the UE 115 may transmit the PUCCH on the same subband 415 used to transmit msg3 (e.g., subband 415-c), such that the PUCCH transmission may overlap in frequency with the selected RO (e.g., RO 3).

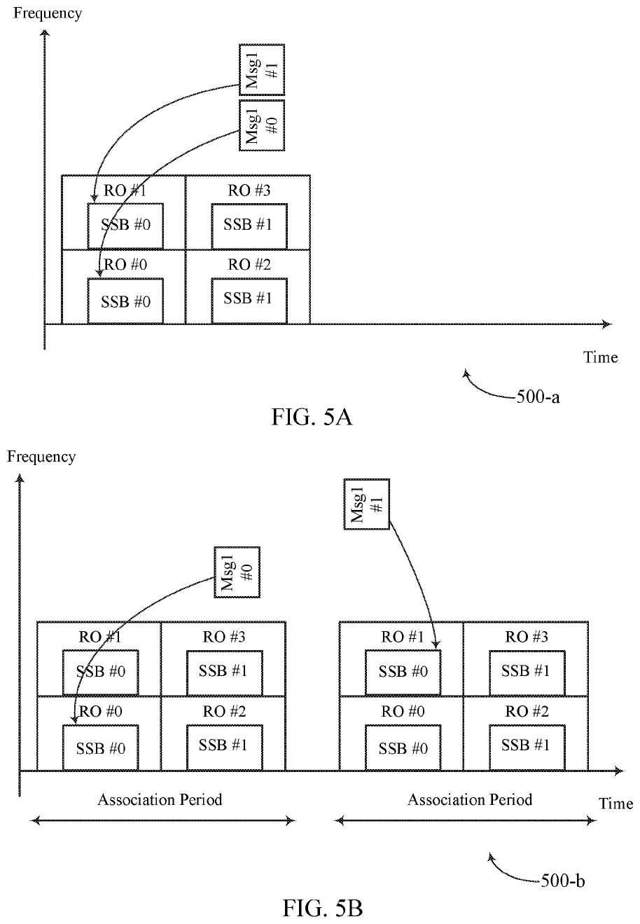

FIGS. 5A and 5B illustrate examples of frequency mapping schemes that supports techniques for frequency resource allocation in RACH in accordance with one or more aspects of the present disclosure. In some examples, the frequency mapping schemes 500-a and 500-b may implement aspects of wireless communications system 100, wireless communications system 200, frequency resource allocation scheme 300, and frequency resource allocation scheme 400. For example, the frequency mapping schemes 500-a and 500-b may illustrate aspects of techniques performed by a UE 115, which may be examples of UEs 115 as described with reference to FIGS. 1 through 3. For example, the UE 115 may transmit a first message (e.g., a msg1) of the RACH procedure using one or more ROs.

In frequency mapping scheme 500-a, a UE 115 may perform multiple PRACH (e.g., msg1) transmissions with different beams, which may allow for increased wireless coverage for eRedCap UEs. For example, the UE 115 may use a group of beams associated with a group of SSBs (e.g., SSB #0 and SSB #1) to transmit multiple PRACH transmissions (e.g., msg1 #0 and msg1 #1) as part of the four-step RACH procedure. The SSBs may be associated with multiple ROs (e.g., RO 0, RO 1, RO 2, and RO 3). The PRACH transmission may be associated with short sequence PRACH formats, long sequence PRACH formats, or both. In some examples, as illustrated in frequency mapping scheme 500-a, the UE 115-a may transmit the multiple PRACH transmissions using ROs that differ in frequency range (e.g., RO 0 and RO 1) (e.g., the transmissions may be frequency division multiplexed with the ROs). For example, the UE 115 may transmit a first part of the PRACH transmission (e.g., msg1 #0) may be transmitted on RO 0 using SSB #0, and the UE 1115 may transmit a second part of the PRACH transmission (e.g., msg1 #1) may be transmitted on RO 1 using SSB #0. In this case, the multiple PRACH transmissions are transmitted using a same beam (e.g., a beam associated with SSB #0). In the example of the frequency mapping scheme 500-a, repetition may be equal to 2,

$${N}_{T x}^{S S B}$$

may be equal 2, N may be equal to ½, and MSG1-FDM may be equal to 2, where

$${N}_{T x}^{S S B}$$

is the number of synchronization signal blocks, N is the number of synchronization signal/physical block channel indexes associated with one random access occasion, and MSG1-FDM may be frequency division multiplexing for the uplink transmission.

Additionally, or alternatively, the UE 115 may transmit msg3 of the RACH procedure. For example, if the UE 115 transmits multiple PRACH transmissions, the UE 115 may transmit msg3 using a subband fully overlapping in frequency with (e.g., fully included within) the RO used for the last PRACH transmission (e.g., msg1 #1). Additionally, or alternatively, the UE 115 may transmit msg3 using a subband fully overlapping in frequency with (e.g., fully included within) the RO used for the first PRACH transmission (e.g., msg1 #0).

In frequency mapping scheme 500-b, a UE 115 may perform multiple PRACH (e.g., msg1) transmissions with different beams at different periods of time (e.g., association periods), which may allow for increased wireless coverage for eRedCap UEs. For example, the UE 115 may use a group of beams associated with a group of SSBs (e.g., SSB #0 and SSB #1) to transmit multiple PRACH transmissions (e.g., msg1 #0 and msg1 #1). The SSBs may be associated with multiple ROs (e.g., RO 0, RO 1, RO 2, and RO 3) at different association periods. In some examples, as illustrated in frequency mapping scheme 500-b, the UE 115-a may transmit the multiple PRACH transmissions using ROs that differ in frequency range and in the time domain (e.g., RO 0 in the first association period and RO 1 in the second association period) (e.g., the transmissions may be frequency hopped with the ROs). For example, the UE 115 may transmit a first part of the PRACH transmission (e.g., msg1 #0) may be transmitted on RO 0 in the first association period using SSB #0, and the UE 1115 may transmit a second part of the PRACH transmission (e.g., msg1 #1) may be transmitted on RO 1 in the second association period using SSB #0. In this case, the multiple PRACH transmissions are transmitted using a same beam (e.g., a beam associated with SSB #0).

Additionally, or alternatively, the UE 115 may transmit msg3 of the RACH procedure. For example, if the UE 115 transmits multiple PRACH transmissions, the UE 115 may transmit msg3 using a subband fully overlapping in frequency with (e.g., fully included within) the RO used for the last PRACH transmission (e.g., msg1 #1). Additionally, or alternatively, the UE 115 may transmit msg3 using a subband fully overlapping in frequency with (e.g., fully included within) the RO used for the first PRACH transmission (e.g., msg1 #0). In the example of the frequency mapping scheme 500-b, repetition may be equal to 2,

$${N}_{T x}^{S S B}$$

may be equal to 2, N may be equal to ½, and MSG1-FDM may be equal to 2, where

$${N}_{T x}^{S S B}$$

is the number of synchronization signal blocks, N is the number of synchronization signal/physical block channel indexes associated with one random access occasion, and MSG1-FDM may be frequency division multiplexing for the uplink transmission.

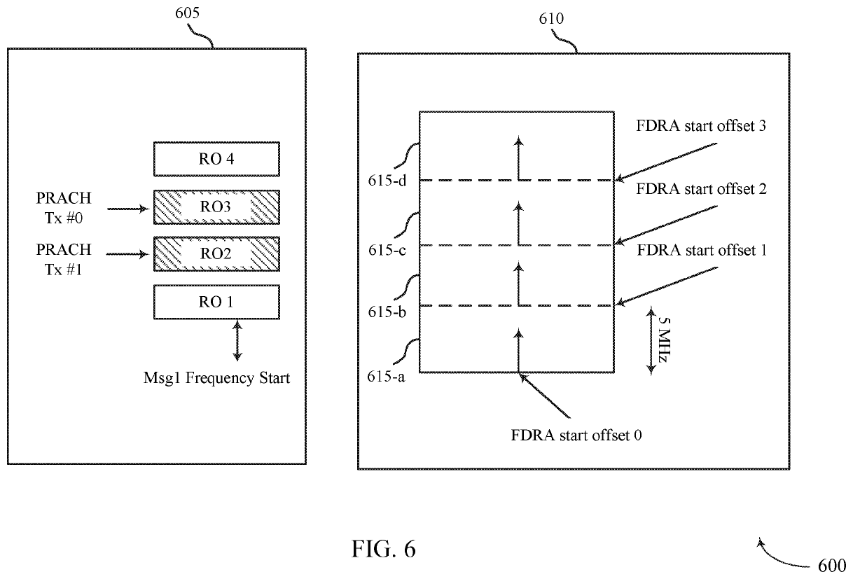

FIG. 6 illustrates an example of a frequency resource allocation scheme 600 that supports techniques for frequency resource allocation in RACH in accordance with one or more aspects of the present disclosure. In some examples, the frequency resource allocation scheme 600 may implement aspects of wireless communications system 100 wireless communications system 200, frequency resource allocation scheme 300, frequency resource allocation scheme 400, and frequency mapping schemes 500-a and 500-b. For example, the frequency resource allocation scheme 600 may illustrate aspects of techniques performed by a network entity 105 and a UE 115, which may be examples of network entities 105 and UEs 115 as described with reference to FIGS. 1 through 3. For example, the network entity 105 may transmit a bandwidth part indication of a bandwidth part 610 to the UE 115, and the UE 115 may determine a frequency resource allocation for transmission based on the bandwidth part indication.

In some examples, the UE 115 may perform multiple PRACH transmissions (e.g., PRACH Tx #0 and PRACH Tx #1) using multiple ROs 605. For example, the UE 115 may select a first RO (e.g., RO 3) of multiple ROs 605 to transmit msg1 #0 (e.g., PRACH Tx #0) of the RACH procedure to a network entity 105. Additionally, or alternatively, the UE 115 may select a second RO (e.g., RO 2) of multiple ROs 605 to transmit msg1 #1 (e.g., PRACH Tx #1) of the RACH procedure to a network entity 105. In some examples, the UE 115 may determine a subband 415 to transmit msg3 (e.g., a PUSCH transmission) based on the ROs used for the multiple PRACH transmissions (e.g., RO 2 and RO 3). In one example, the UE 115 may transmit msg3 using a subband (e.g., subband 615-b) overlapping in frequency with the RO used for the last PRACH transmission (e.g., RO 2). Additionally, or alternatively, the UE 115 may transmit msg3 using a subband (e.g., subband 615-c) fully overlapping in frequency with (e.g., fully included within) the RO used for the first PRACH transmission (e.g., RO 3).

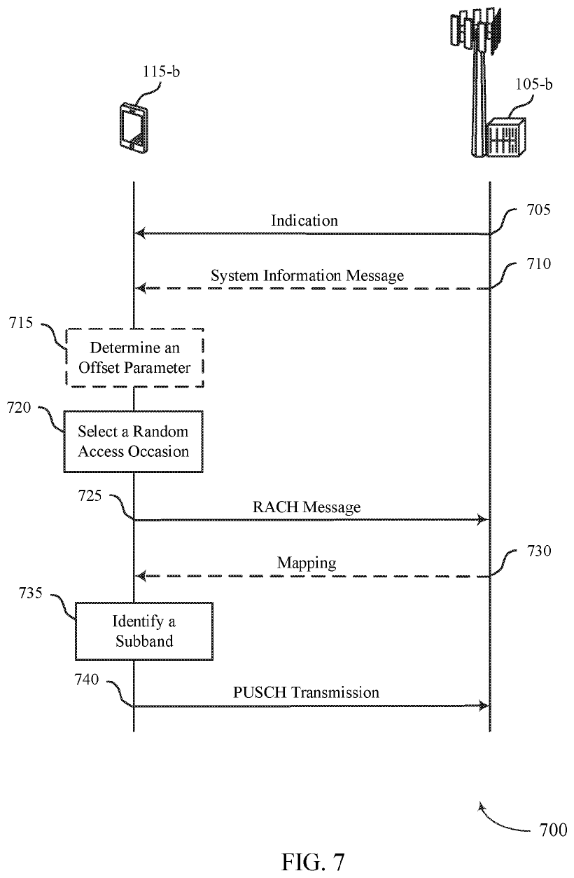

FIG. 7 illustrates an example of a process flow 700 that supports techniques for frequency resource allocation in RACH in accordance with one or more aspects of the present disclosure. In some examples, process flow 700 may implement aspects of wireless communications systems 100, wireless communications system 200, frequency resource allocation scheme 300, frequency resource allocation scheme 400, frequency mapping scheme 500-a, frequency mapping scheme 500-b, and frequency resource allocation scheme 600.

The process flow 700 may illustrate an example of a UE 115-b (e.g., an eRedCap UE) and a network entity 105-b performing a RACH procedure based on a frequency resource allocation in accordance with one or more aspects of the present disclosure, which may be examples of a network entity 105 and a UE 115 as described with reference to FIGS. 1 through 6. Alternative examples of the following may be implemented, where some processes are performed in a different order than described or are not performed. In some cases, processes may include additional features not mentioned below, or further processes may be added.

At 705, a network entity 105-b may transmit, to a UE 115-b, an indication of an uplink bandwidth part associated with a random access procedure. In some examples, the uplink bandwidth part may include multiple subbands corresponding to multiple ROs.

At 710, in some examples, the network entity 105-b may optionally transmit, to the UE 115-b, a system information message including the offset parameter. The offset parameter may indicate a same offset for each subband of the multiple subbands, a different offset for each subband of the multiple subbands, or both. The offset parameter may be based on one or more of a maximum bandwidth of the UE 115-b, an initial physical resource block of the uplink bandwidth part, or a sub-carrier spacing of the uplink bandwidth part. Each subband of the multiple subbands may include a predefined number of resource blocks (RBs).

At 715, in some examples, the UE 115-b may optionally determine the offset parameter based on receiving the system information message. At 720, the UE 115-b may select an RO from the multiple ROs based on the offset parameter.

At 725, the UE 115-b may transmit an uplink random access (e.g., RACH) message at the RO (e.g., the selected RO) of the multiple ROs. In some examples, the UE 115-b may transmit one or more uplink RACH preambles at one or more ROs of the multiple ROs, where each of the one or more uplink random access message instances corresponding to a first message (e.g., msg1) of the RACH procedure may be transmitted on a different RO, and where the same preamble may be repeated in each random access message instance. In this example, the one or more ROs may be different in time, frequency, or both. In some examples, the UE 115-b may transmit a physical uplink shared (e.g., PUSCH) message in a subband of the multiple subbands overlapping in frequency with the RO of the one or more ROs, where the RO may include the RO at which a last uplink random access message instance of the one or more random access message instances was transmitted, and where the one or more uplink random access message instances may correspond to a first message of the random access (e.g., RACH) procedure. In some examples, the UE 115-b may transmit the physical uplink shared (e.g., PUSCH) message in a subband of the multiple subbands overlapping in frequency with the RO of the one or more ROs, where the RO may include the RO at which a first uplink random access message instance of the one or more random access message instances was transmitted.

At 730, in some examples, the network entity 105-b may optionally transmit, to the UE 115-b, a mapping between the multiple ROs and the multiple subbands. The mapping may be one or more of a one to one mapping between the multiple ROs and the multiple subbands, a mapping between the RO of the multiple ROs and the multiple subbands, or a mapping between the subband of the multiple subbands and multiple ROs. In some examples, the network entity 105-b may identify a subband of the multiple subbands overlapping in frequency with the RO of the multiple ROs.

At 735, the UE 115-b may identify a subband of the multiple subbands overlapping in frequency with the RO of the multiple ROs. In some examples, the UE 115-b may select the subband of the multiple subbands for transmitting a second uplink RACH message based on the mapping. The second uplink RACH message may be a PUSCH transmission, a PUCCH transmission, or both. In some examples, the UE 115-b may transmit an initial subset of a PUSCH in a first resource block of the subband of the multiple subbands.

At 740, the UE 115-b may transmit, to the network entity 105-b, the second uplink RACH message in a subband of the multiple subbands overlapping in frequency with the RO of the multiple ROs, where the uplink RACH message may include a PRACH preamble and the second uplink RACH message may include a PUSCH. In some examples, the UE 115-b may transmit the second uplink RACH message in a subband of the multiple of subbands overlapping in frequency with the RO of the multiple Ros, where the uplink RACH message may include a physical random access preamble and the second uplink RACH message may include a PUCCH.

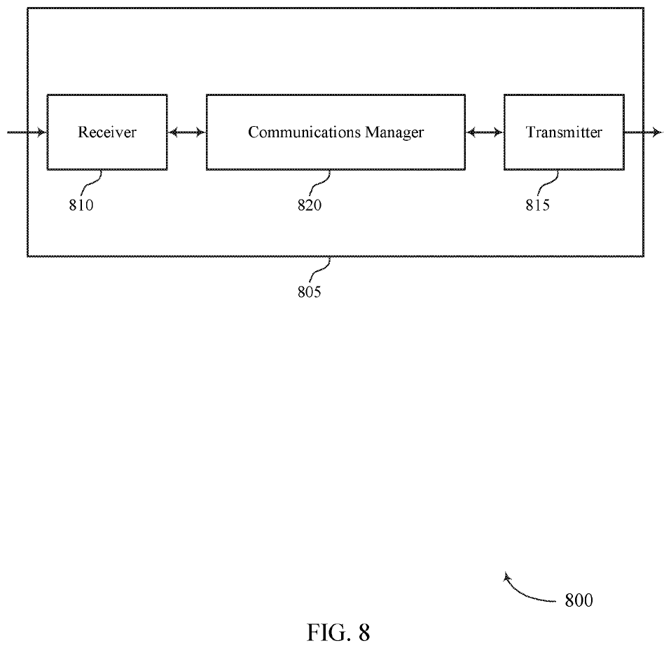

FIG. 8 shows a block diagram 800 of a device 805 that supports techniques for frequency resource allocation in RACH in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for frequency resource allocation in RACH). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for frequency resource allocation in RACH). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for frequency resource allocation in RACH as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 may be configured as or otherwise support a means for receiving an indication of an uplink bandwidth part associated with a random access procedure, the uplink bandwidth part including a set of multiple subbands corresponding to a set of multiple random access occasions. The communications manager 820 may be configured as or otherwise support a means for selecting a random access occasion from the set of multiple random access occasions based on an offset parameter. The communications manager 820 may be configured as or otherwise support a means for transmitting an uplink RACH message at the random access occasion of the set of multiple random access occasions.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for frequency resource allocation in a RACH, which may result in reduced processing, reduced power consumption, and more efficient utilization of communication resources.

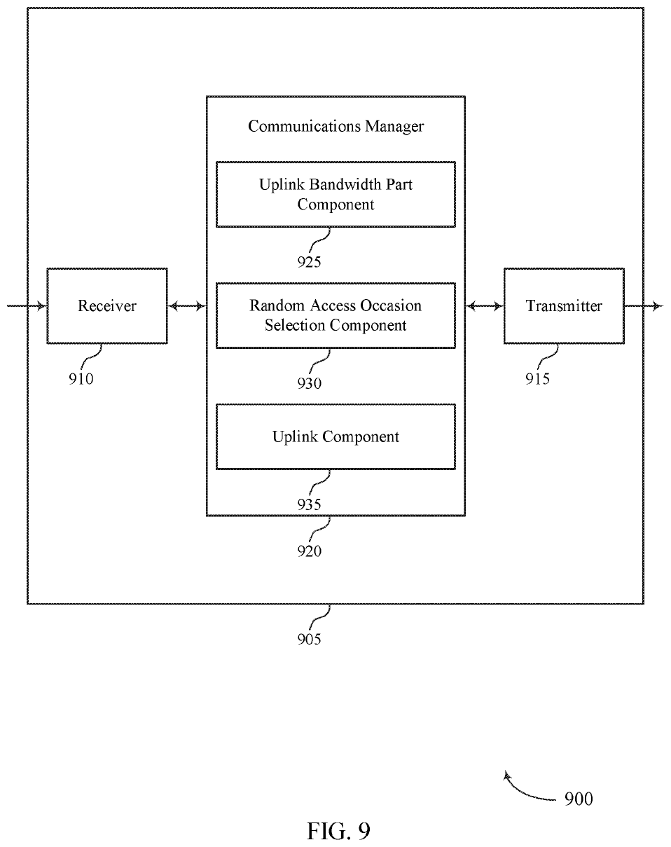

FIG. 9 shows a block diagram 900 of a device 905 that supports techniques for frequency resource allocation in RACH in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for frequency resource allocation in RACH). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for frequency resource allocation in RACH). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for frequency resource allocation in RACH as described herein. For example, the communications manager 920 may include an uplink bandwidth part component 925, a random access occasion selection component 930, an uplink component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The uplink bandwidth part component 925 may be configured as or otherwise support a means for receiving an indication of an uplink bandwidth part associated with a random access procedure, the uplink bandwidth part including a set of multiple subbands corresponding to a set of multiple random access occasions. The random access occasion selection component 930 may be configured as or otherwise support a means for selecting a random access occasion from the set of multiple random access occasions based on an offset parameter. The uplink component 935 may be configured as or otherwise support a means for transmitting an uplink RACH message at the random access occasion of the set of multiple random access occasions.

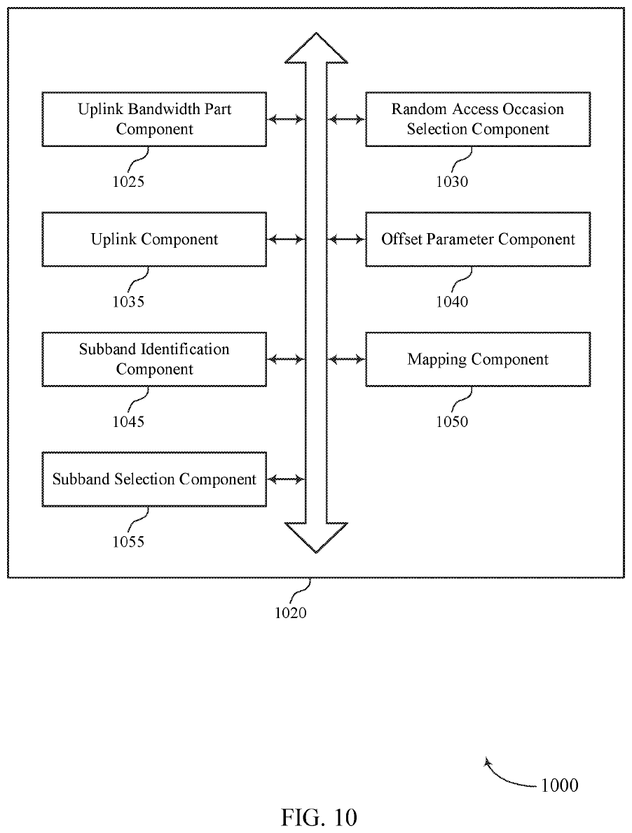

FIG. 10 shows a block diagram 1000 of a communications manager 1020 that supports techniques for frequency resource allocation in RACH in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for frequency resource allocation in RACH as described herein. For example, the communications manager 1020 may include an uplink bandwidth part component 1025, a random access occasion selection component 1030, an uplink component 1035, an offset parameter component 1040, a subband identification component 1045, a mapping component 1050, a subband selection component 1055, or any combination thereof. Each of these components may communicate, directly or indirectly, with one another (e.g., via one or more buses).

The communications manager 1020 may support wireless communication at a UE in accordance with examples as disclosed herein. The uplink bandwidth part component 1025 may be configured as or otherwise support a means for receiving an indication of an uplink bandwidth part associated with a random access procedure, the uplink bandwidth part including a set of multiple subbands corresponding to a set of multiple random access occasions. The random access occasion selection component 1030 may be configured as or otherwise support a means for selecting a random access occasion from the set of multiple random access occasions based on an offset parameter. The uplink component 1035 may be configured as or otherwise support a means for transmitting an uplink RACH message at the random access occasion of the set of multiple random access occasions.

In some examples, the offset parameter component 1040 may be configured as or otherwise support a means for receiving a system information message including the offset parameter. In some examples, the offset parameter component 1040 may be configured as or otherwise support a means for determining the offset parameter based on receiving the system information message.

In some examples, the subband identification component 1045 may be configured as or otherwise support a means for identifying a subband of the set of multiple subbands overlapping in frequency with the random access occasion of the set of multiple random access occasions. In some examples, the uplink component 1035 may be configured as or otherwise support a means for transmitting an initial subset of a physical uplink shared channel in a first resource block of the subband of the set of multiple subbands.

In some examples, the uplink component 1035 may be configured as or otherwise support a means for transmitting a second uplink RACH message in a subband of the set of multiple subbands overlapping in frequency with the random access occasion of the set of multiple random access occasions, where the uplink RACH message includes a physical RACH preamble and the second uplink RACH message includes a physical uplink shared channel.

In some examples, to support transmitting the second uplink RACH message in the subband of the set of multiple subbands, the mapping component 1050 may be configured as or otherwise support a means for receiving, from a network entity, a mapping between the set of multiple random access occasions and the set of multiple subbands. In some examples, to support transmitting the second uplink RACH message in the subband of the set of multiple subbands, the subband selection component 1055 may be configured as or otherwise support a means for selecting the subband of the set of multiple subbands for transmitting the second uplink RACH message based on the mapping.

In some examples, the mapping includes at least one of a one to one mapping between the set of multiple random access occasions and the set of multiple subbands, a mapping between the random access occasion of the set of multiple random access occasions and the set of multiple subbands, a mapping between the subband of the set of multiple subbands and the set of multiple random access occasions, or a combination thereof.

In some examples, to support transmitting the uplink RACH message, the uplink component 1035 may be configured as or otherwise support a means for transmitting one or more uplink random access message instances at one or more random access occasions of the set of multiple random access occasions, where each of the one or more uplink random access message instances corresponding to a first message of the random access procedure are transmitted on a different random access occasion, where a same preamble is repeated in each random access message instance. In some examples, the one or more random access occasions of the set of multiple random access occasions are different in time, frequency, or a combination thereof.

In some examples, the uplink component 1035 may be configured as or otherwise support a means for transmitting a physical uplink shared message in a subband of the set of multiple subbands overlapping in frequency with the random access occasion of the one or more random access occasions, where the random access occasion includes the random access occasion at which a last uplink random access message instance of the one or more uplink random access message instances was transmitted, where the one or more uplink random access message instances correspond to a first message of the random access procedure.

In some examples, the uplink component 1035 may be configured as or otherwise support a means for transmitting a physical uplink shared message in a subband of the set of multiple subbands overlapping in frequency with the random access occasion of the one or more random access occasions, where the random access occasion includes the random access occasion at which a first uplink random access message instance corresponding to the first message of the random access procedure was transmitted.

In some examples, the uplink component 1035 may be configured as or otherwise support a means for transmitting a second uplink RACH message in a subband of the set of multiple subbands overlapping in frequency with the random access occasion of the set of multiple random access occasions, where the uplink RACH message includes a physical RACH preamble and the second uplink RACH message includes a physical uplink control channel.

In some examples, the offset parameter indicates at least one of a same offset for each subband of the set of multiple subbands, a different offset for each subband of the set of multiple subbands, or a combination thereof.

In some examples, the offset parameter is based on at least one of a maximum bandwidth of the UE, an initial physical resource block of the uplink bandwidth part, a sub-carrier spacing of the uplink bandwidth part, or a combination thereof. In some examples, a subband of the set of multiple subbands includes a predefined number of resource blocks.

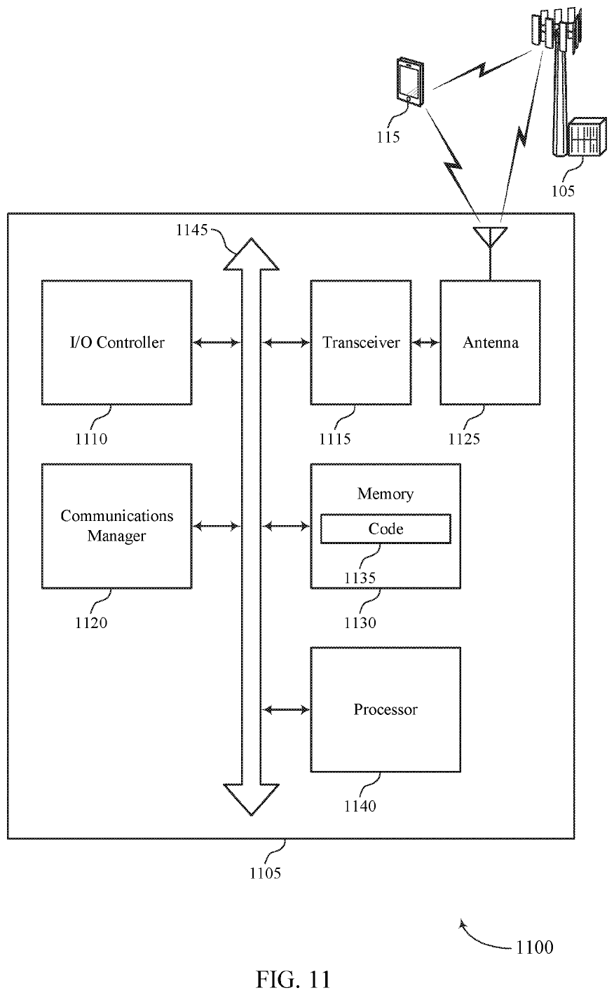

FIG. 11 shows a diagram of a system 1100 including a device 1105 that supports techniques for frequency resource allocation in RACH in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for frequency resource allocation in RACH). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving an indication of an uplink bandwidth part associated with a random access procedure, the uplink bandwidth part including a set of multiple subbands corresponding to a set of multiple random access occasions. The communications manager 1120 may be configured as or otherwise support a means for selecting a random access occasion from the set of multiple random access occasions based on an offset parameter. The communications manager 1120 may be configured as or otherwise support a means for transmitting an uplink RACH message at the random access occasion of the set of multiple random access occasions.

By including or configuring the communications manager 1120 in accordance with examples as described herein, the device 1105 may support techniques for frequency resource allocation in a RACH, which may result in improved communication reliability, reduced latency, reduced power consumption, and more efficient utilization of communication resources.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for frequency resource allocation in RACH as described herein, or the processor 1140 and the memory 1130 may be otherwise configured to perform or support such operations.

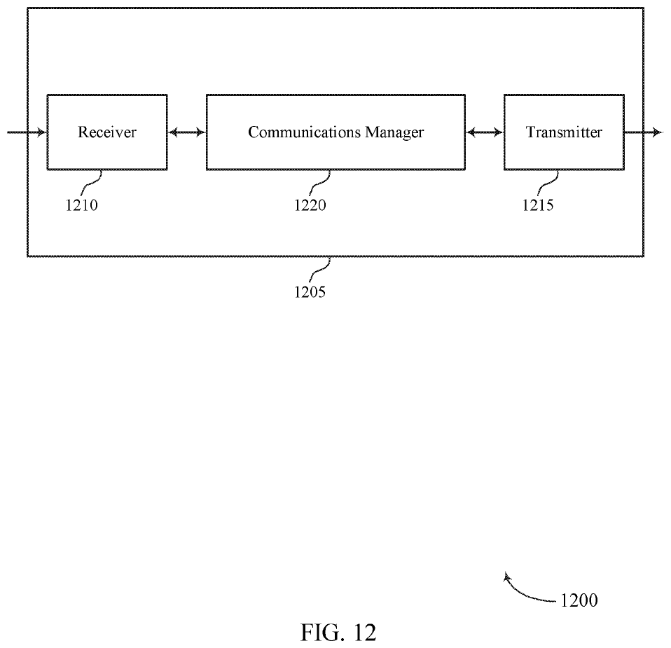

FIG. 12 shows a block diagram 1200 of a device 1205 that supports techniques for frequency resource allocation in RACH in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of techniques for frequency resource allocation in RACH as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 may be configured as or otherwise support a means for transmitting, to a UE, an indication of an uplink bandwidth part associated with a random access procedure, the uplink bandwidth part including a set of multiple subbands corresponding to a set of multiple random access occasions. The communications manager 1220 may be configured as or otherwise support a means for receiving an uplink RACH message at a random access occasion of the set of multiple random access occasions, where the random access occasion of the set of multiple random access occasions based on an offset parameter.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for frequency resource allocation in a RACH, which may result in reduced processing, reduced power consumption, and more efficient utilization of communication resources.

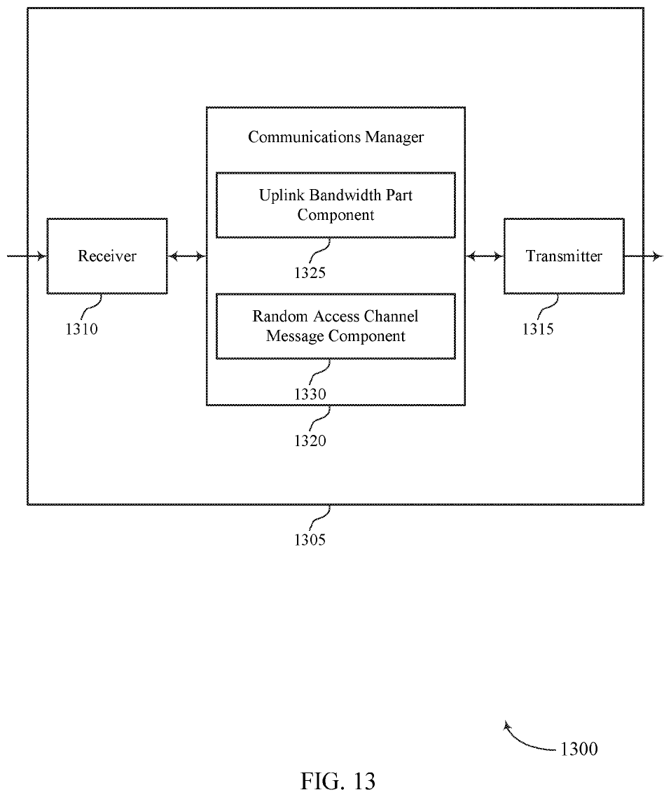

FIG. 13 shows a block diagram 1300 of a device 1305 that supports techniques for frequency resource allocation in RACH in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of techniques for frequency resource allocation in RACH as described herein. For example, the communications manager 1320 may include an uplink bandwidth part component 1325 a random access channel message component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The uplink bandwidth part component 1325 may be configured as or otherwise support a means for transmitting, to a UE, an indication of an uplink bandwidth part associated with a random access procedure, the uplink bandwidth part including a set of multiple subbands corresponding to a set of multiple random access occasions. The random access channel message component 1330 may be configured as or otherwise support a means for receiving an uplink RACH message at a random access occasion of the set of multiple random access occasions, where the random access occasion of the set of multiple random access occasions based on an offset parameter.

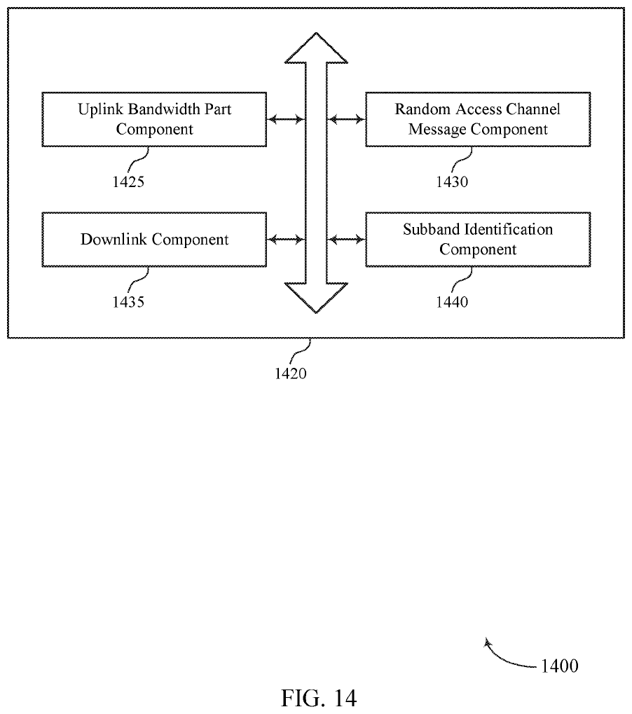

FIG. 14 shows a block diagram 1400 of a communications manager 1420 that supports techniques for frequency resource allocation in RACH in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for frequency resource allocation in RACH as described herein. For example, the communications manager 1420 may include an uplink bandwidth part component 1425, a random access channel message component 1430, a downlink component 1435, a subband identification component 1440, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The uplink bandwidth part component 1425 may be configured as or otherwise support a means for transmitting, to a UE, an indication of an uplink bandwidth part associated with a random access procedure, the uplink bandwidth part including a set of multiple subbands corresponding to a set of multiple random access occasions. The random access channel message component 1430 may be configured as or otherwise support a means for receiving an uplink RACH message at a random access occasion of the set of multiple random access occasions, where the random access occasion of the set of multiple random access occasions based on an offset parameter.

In some examples, the downlink component 1435 may be configured as or otherwise support a means for transmitting, to the UE, a system information message including the offset parameter.

In some examples, the subband identification component 1440 may be configured as or otherwise support a means for identifying a subband of the set of multiple subbands overlapping in frequency with the random access occasion of the set of multiple random access occasions. In some examples, the random access channel message component 1430 may be configured as or otherwise support a means for receiving an initial subset of a physical uplink shared channel in a first resource block of the subband of the set of multiple subbands.

In some examples, the random access channel message component 1430 may be configured as or otherwise support a means for receiving a second uplink RACH message in a subband of the set of multiple subbands overlapping in frequency with the random access occasion of the set of multiple random access occasions, where the uplink RACH message includes a physical RACH preamble and the second uplink RACH message includes a physical uplink shared channel.

In some examples, to support receiving the second uplink RACH message in the subband of the set of multiple subbands, the downlink component 1435 may be configured as or otherwise support a means for transmitting, to the UE, a mapping between the set of multiple random access occasions and the set of multiple subbands, where the subband of the set of multiple subbands for transmitting the second uplink RACH message is selected based on the mapping.

In some examples, the mapping includes at least one of a one to one mapping between the set of multiple random access occasions and the set of multiple subbands, a mapping between the random access occasion of the set of multiple random access occasions and the set of multiple subbands, a mapping between the subband of the set of multiple subbands and the set of multiple random access occasions, or a combination thereof.

In some examples, to support receiving the uplink RACH message, the random access channel message component 1430 may be configured as or otherwise support a means for receiving one or more uplink random access message instances at one or more random access occasions of the set of multiple random access occasions, where each of the one or more uplink random access message instances corresponding to a first message of the random access procedure are transmitted on a different random access occasion, where a same preamble is repeated in each random access message instance. In some examples, the one or more random access occasions of the set of multiple random access occasions are different in time, frequency, or a combination thereof.

In some examples, the random access channel message component 1430 may be configured as or otherwise support a means for receiving a physical uplink shared message in a subband of the set of multiple subbands overlapping in frequency with the random access occasion of the one or more random access occasions, where the random access occasion includes the random access occasion at which a last uplink random access message instance of the one or more uplink random access instances was received, where the one or more uplink random access message instances correspond to a first message of the random access procedure.

In some examples, the random access channel message component 1430 may be configured as or otherwise support a means for receiving a physical uplink shared message in a subband of the set of multiple subbands overlapping in frequency with the random access occasion of the one or more random access occasions, where the random access occasion includes the random access occasion at which a first uplink random access message instance corresponding to the first message of the random access procedure was transmitted.

In some examples, the random access channel message component 1430 may be configured as or otherwise support a means for receiving a second uplink RACH message in a subband of the set of multiple subbands overlapping in frequency with the random access occasion of the set of multiple random access occasions, where the uplink RACH message includes a physical RACH preamble and the second uplink RACH message includes a physical uplink control channel.

In some examples, the offset parameter indicates at least one of a same offset for each subband of the set of multiple subbands, a different offset for each subband of the set of multiple subbands, or a combination thereof.

In some examples, the offset parameter is based on at least one of a maximum bandwidth of the UE, an initial physical resource block of the uplink bandwidth part, a sub-carrier spacing of the uplink bandwidth part, or a combination thereof. In some examples, a subband of the set of multiple subbands includes a predefined number of resource blocks.

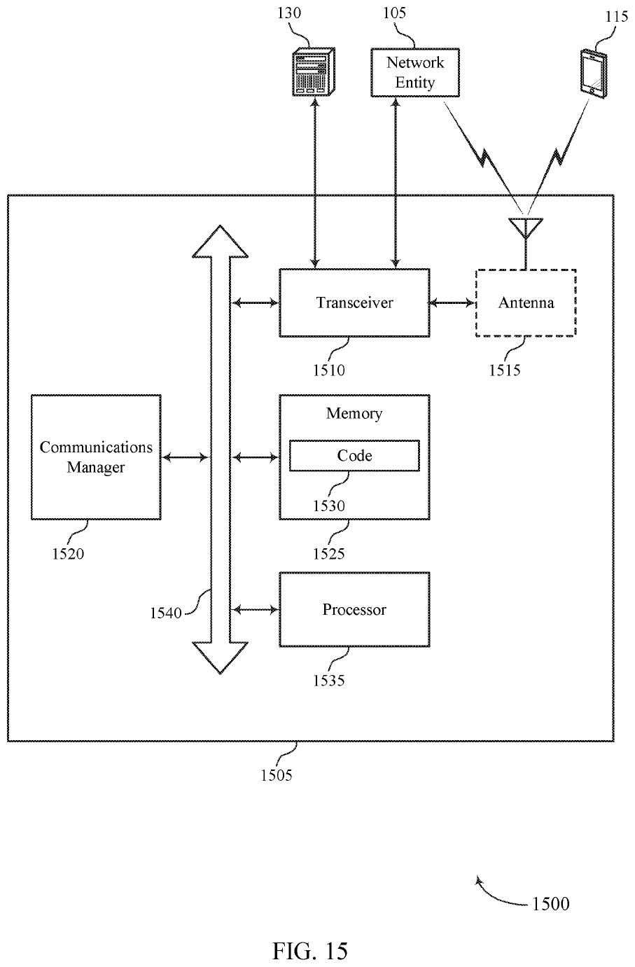

FIG. 15 shows a diagram of a system 1500 including a device 1505 that supports techniques for frequency resource allocation in RACH in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting techniques for frequency resource allocation in RACH). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 may be configured as or otherwise support a means for transmitting, to a UE, an indication of an uplink bandwidth part associated with a random access procedure, the uplink bandwidth part including a set of multiple subbands corresponding to a set of multiple random access occasions. The communications manager 1520 may be configured as or otherwise support a means for receiving an uplink RACH message at a random access occasion of the set of multiple random access occasions, where the random access occasion of the set of multiple random access occasions based on an offset parameter.

By including or configuring the communications manager 1520 in accordance with examples as described herein, the device 1505 may support techniques for frequency resource allocation in a RACH, which may result in improved communication reliability, reduced latency, reduced power consumption, and more efficient utilization of communication resources.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of techniques for frequency resource allocation in RACH as described herein, or the processor 1535 and the memory 1525 may be otherwise configured to perform or support such operations.

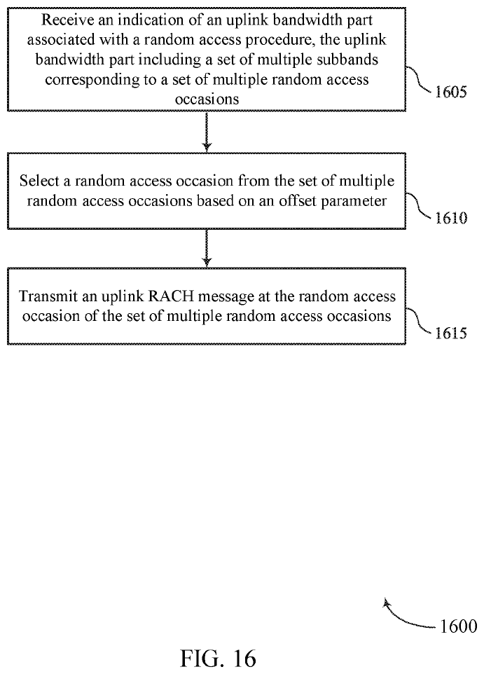

FIG. 16 shows a flowchart illustrating a method 1600 that supports techniques for frequency resource allocation in RACH in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include receiving an indication of an uplink bandwidth part associated with a random access procedure, the uplink bandwidth part including a set of multiple subbands corresponding to a set of multiple random access occasions. The operations of 1605 may be performed in accordance with examples as disclosed herein. In some examples, aspects of the operations of 1605 may be performed by an uplink bandwidth part component 1025 as described with reference to FIG. 10.

At 1610, the method may include selecting a random access occasion from the set of multiple random access occasions based on an offset parameter. The operations of 1610 may be performed in accordance with examples as disclosed herein. In some examples, aspects of the operations of 1610 may be performed by a random access occasion selection component 1030 as described with reference to FIG. 10.

At 1615, the method may include transmitting an uplink RACH message at the random access occasion of the set of multiple random access occasions. The operations of 1615 may be performed in accordance with examples as disclosed herein. In some examples, aspects of the operations of 1615 may be performed by an uplink component 1035 as described with reference to FIG. 10.

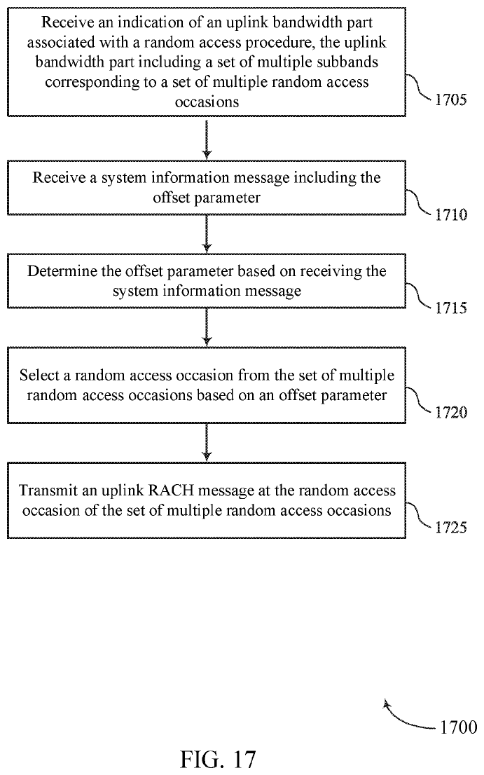

FIG. 17 shows a flowchart illustrating a method 1700 that supports techniques for frequency resource allocation in RACH in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include receiving an indication of an uplink bandwidth part associated with a random access procedure, the uplink bandwidth part including a set of multiple subbands corresponding to a set of multiple random access occasions. The operations of 1705 may be performed in accordance with examples as disclosed herein. In some examples, aspects of the operations of 1705 may be performed by an uplink bandwidth part component 1025 as described with reference to FIG. 10.

At 1710, the method may include receiving a system information message including the offset parameter. The operations of 1710 may be performed in accordance with examples as disclosed herein. In some examples, aspects of the operations of 1710 may be performed by an offset parameter component 1040 as described with reference to FIG. 10.

At 1715, the method may include determining the offset parameter based on receiving the system information message. The operations of 1715 may be performed in accordance with examples as disclosed herein. In some examples, aspects of the operations of 1715 may be performed by an offset parameter component 1040 as described with reference to FIG. 10.

At 1720, the method may include selecting a random access occasion from the set of multiple random access occasions based on an offset parameter. The operations of 1720 may be performed in accordance with examples as disclosed herein. In some examples, aspects of the operations of 1720 may be performed by a random access occasion selection component 1030 as described with reference to FIG. 10.

At 1725, the method may include transmitting an uplink RACH message at the random access occasion of the set of multiple random access occasions. The operations of 1725 may be performed in accordance with examples as disclosed herein. In some examples, aspects of the operations of 1725 may be performed by an uplink component 1035 as described with reference to FIG. 10.

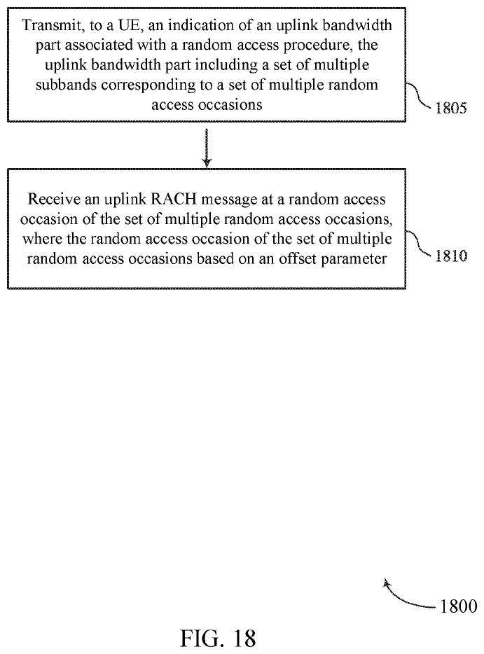

FIG. 18 shows a flowchart illustrating a method 1800 that supports techniques for frequency resource allocation in RACH in accordance with one or more aspects of the present disclosure. The operations of the method 1800 may be implemented by a network entity or its components as described herein. For example, the operations of the method 1800 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, an indication of an uplink bandwidth part associated with a random access procedure, the uplink bandwidth part including a set of multiple subbands corresponding to a set of multiple random access occasions. The operations of 1805 may be performed in accordance with examples as disclosed herein. In some examples, aspects of the operations of 1805 may be performed by an uplink bandwidth part component 1425 as described with reference to FIG. 14.

At 1810, the method may include receiving an uplink RACH message at a random access occasion of the set of multiple random access occasions, where the random access occasion of the set of multiple random access occasions based on an offset parameter. The operations of 1810 may be performed in accordance with examples as disclosed herein. In some examples, aspects of the operations of 1810 may be performed by a RACH message component 1430 as described with reference to FIG. 14.

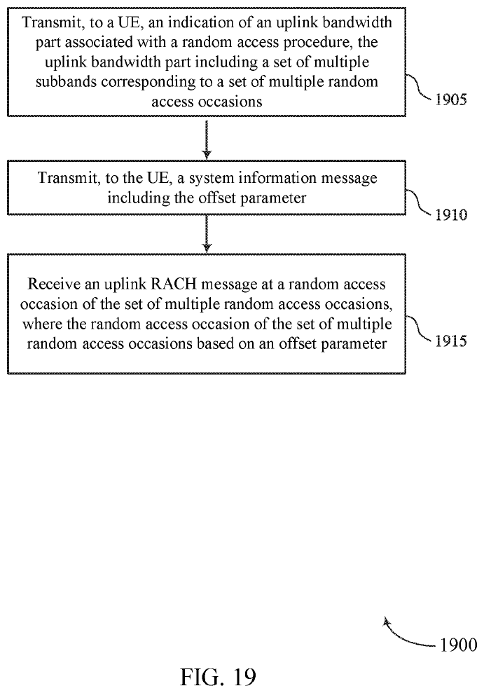

FIG. 19 shows a flowchart illustrating a method 1900 that supports techniques for frequency resource allocation in RACH in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the network entity to perform the described functions. Additionally, or alternatively, the network entity may perform aspects of the described functions using special-purpose hardware.

At 1905, the method may include transmitting, to a UE, an indication of an uplink bandwidth part associated with a random access procedure, the uplink bandwidth part including a set of multiple subbands corresponding to a set of multiple random access occasions. The operations of 1905 may be performed in accordance with examples as disclosed herein. In some examples, aspects of the operations of 1905 may be performed by an uplink bandwidth part component 1425 as described with reference to FIG. 14.

At 1910, the method may include transmitting, to the UE, a system information message including the offset parameter. The operations of 1910 may be performed in accordance with examples as disclosed herein. In some examples, aspects of the operations of 1910 may be performed by a downlink component 1435 as described with reference to FIG. 14.

At 1915, the method may include receiving an uplink RACH message at a random access occasion of the set of multiple random access occasions, where the random access occasion of the set of multiple random access occasions based on an offset parameter. The operations of 1915 may be performed in accordance with examples as disclosed herein. In some examples, aspects of the operations of 1915 may be performed by a RACH message component 1430 as described with reference to FIG. 14.

The following provides an overview of aspects of the present disclosure:

Aspect 1: A method for wireless communication at a UE, comprising: receiving an indication of an uplink bandwidth part associated with a random access procedure, the uplink bandwidth part comprising a plurality of subbands corresponding to a plurality of random access occasions; selecting a random access occasion from the plurality of random access occasions based at least in part on an offset parameter; and transmitting an uplink random access channel message at the random access occasion of the plurality of random access occasions.

Aspect 2: The method of aspect 1, further comprising: receiving a system information message comprising the offset parameter; and determining the offset parameter based at least in part on receiving the system information message.

Aspect 3: The method of any of aspects 1 through 2, further comprising: identifying a subband of the plurality of subbands overlapping in frequency with the random access occasion of the plurality of random access occasions; and transmitting an initial subset of a physical uplink shared channel in a first resource block of the subband of the plurality of subbands.

Aspect 4: The method of any of aspects 1 through 3, further comprising: transmitting a second uplink random access channel message in a subband of the plurality of subbands overlapping in frequency with the random access occasion of the plurality of random access occasions, wherein the uplink random access channel message comprises a physical random access channel preamble and the second uplink random access channel message comprises a physical uplink shared channel.

Aspect 5: The method of aspect 4, wherein transmitting the second uplink random access channel message in the subband of the plurality of subbands comprises: receiving, from a network entity, a mapping between the plurality of random access occasions and the plurality of subbands; and selecting the subband of the plurality of subbands for transmitting the second uplink random access channel message based at least in part on the mapping.

Aspect 6: The method of aspect 5, wherein the mapping comprises at least one of a one to one mapping between the plurality of random access occasions and the plurality of subbands, a mapping between the random access occasion of the plurality of random access occasions and the plurality of subbands, a mapping between the subband of the plurality of subbands and the plurality of random access occasions, or a combination thereof.

Aspect 7: The method of any of aspects 1 through 6, wherein transmitting the uplink random access channel message further comprises: transmitting one or more uplink random access preambles at one or more random access occasions of the plurality of random access occasions, wherein each of the one or more uplink random access message instances corresponding to a first message of the random access procedure are transmitted on a different random access occasion, wherein the same preamble is repeated in each random access message instance.

Aspect 8: The method of aspect 7, wherein the one or more random access occasions of the plurality of random access occasions are different in time, frequency, or a combination thereof.

Aspect 9: The method of any of aspects 7 through 8, further comprising: transmitting a physical uplink shared message in a subband of the plurality of subbands overlapping in frequency with the random access occasion of the one or more random access occasions, wherein the random access occasion comprises the random access occasion at which a last uplink random access message instance of the one or more uplink random access message instances was transmitted, wherein the one or more uplink random access message instances correspond to a first message of the random access procedure.

Aspect 10: The method of any of aspects 7 through 9, further comprising: transmitting a physical uplink shared message in a subband of the plurality of subbands overlapping in frequency with the random access occasion of the one or more random access occasions, wherein the random access occasion comprises the random access occasion at which a first uplink random access message instance corresponding to the first message of the random access procedure was transmitted.

Aspect 11: The method of any of aspects 1 through 10, further comprising: transmitting a second uplink random access channel message in a subband of the plurality of subbands overlapping in frequency with the random access occasion of the plurality of random access occasions, wherein the uplink random access channel message comprises a physical random access channel preamble and the second uplink random access channel message comprises a physical uplink control channel.

Aspect 12: The method of any of aspects 1 through 11, wherein the offset parameter indicates at least one of a same offset for each subband of the plurality of subbands, a different offset for each subband of the plurality of subbands, or a combination thereof.

Aspect 13: The method of any of aspects 1 through 12, wherein the offset parameter is based at least in part on at least one of a maximum bandwidth of the UE, an initial physical resource block of the uplink bandwidth part, a sub-carrier spacing of the uplink bandwidth part, or a combination thereof.

Aspect 14: The method of any of aspects 1 through 13, wherein a subband of the plurality of subbands comprises a predefined number of resource blocks.

Aspect 15: A method for wireless communication at a network entity, comprising: transmitting, to a UE, an indication of an uplink bandwidth part associated with a random access procedure, the uplink bandwidth part comprising a plurality of subbands corresponding to a plurality of random access occasions; and receiving an uplink random access channel message at a random access occasion of the plurality of random access occasions, wherein the random access occasion of the plurality of random access occasions based at least in part on an offset parameter.

Aspect 16: The method of aspect 15, further comprising: transmitting, to the UE, a system information message comprising the offset parameter.

Aspect 17: The method of any of aspects 15 through 16, further comprising: identifying a subband of the plurality of subbands overlapping in frequency with the random access occasion of the plurality of random access occasions; and receiving an initial subset of a physical uplink shared channel in a first resource block of the subband of the plurality of subbands.

Aspect 18: The method of any of aspects 15 through 17, further comprising: receiving a second uplink random access channel message in a subband of the plurality of subbands overlapping in frequency with the random access occasion of the plurality of random access occasions, wherein the uplink random access channel message comprises a physical random access channel preamble and the second uplink random access channel message comprises a physical uplink shared channel.

Aspect 19: The method of aspect 18, wherein receiving the second uplink random access channel message in the subband of the plurality of subbands comprises: transmitting, to the UE, a mapping between the plurality of random access occasions and the plurality of subbands, wherein the subband of the plurality of subbands for transmitting the second uplink random access channel message is selected based at least in part on the mapping.

Aspect 20: The method of aspect 19, wherein the mapping comprises at least one of a one to one mapping between the plurality of random access occasions and the plurality of subbands, a mapping between the random access occasion of the plurality of random access occasions and the plurality of subbands, a mapping between the subband of the plurality of subbands and the plurality of random access occasions, or a combination thereof.

Aspect 21: The method of any of aspects 15 through 20, wherein receiving the uplink random access channel message further comprises: receiving one or more uplink random access preambles at one or more random access occasions of the plurality of random access occasions, wherein each of the one or more uplink random access message instances corresponding to a first message of the random access procedure are transmitted on a different random access occasion, wherein the same preamble is repeated in each random access message instance.

Aspect 22: The method of aspect 21, wherein the one or more random access occasions of the plurality of random access occasions are different in time, frequency, or a combination thereof.

Aspect 23: The method of any of aspects 21 through 22, further comprising: receiving a physical uplink shared message in a subband of the plurality of subbands overlapping in frequency with the random access occasion of the one or more random access occasions, wherein the random access occasion comprises the random access occasion at which a last uplink random access message instance of the one or more uplink random access instances was received, wherein the one or more uplink random access message instances correspond to a first message of the random access procedure.

Aspect 24: The method of any of aspects 21 through 23, further comprising: receiving a physical uplink shared message in a subband of the plurality of subbands overlapping in frequency with the random access occasion of the one or more random access occasions, wherein the random access occasion comprises the random access occasion at which a first uplink random access message instance corresponding to the first message of the random access procedure was transmitted.

Aspect 25: The method of any of aspects 15 through 24, further comprising: receiving a second uplink random access channel message in a subband of the plurality of subbands overlapping in frequency with the random access occasion of the plurality of random access occasions, wherein the uplink random access channel message comprises a physical random access channel preamble and the second uplink random access channel message comprises a physical uplink control channel.

Aspect 26: The method of any of aspects 15 through 25, wherein the offset parameter indicates at least one of a same offset for each subband of the plurality of subbands, a different offset for each subband of the plurality of subbands, or a combination thereof.

Aspect 27: The method of any of aspects 15 through 26, wherein the offset parameter is based at least in part on at least one of a maximum bandwidth of the UE, an initial physical resource block of the uplink bandwidth part, a sub-carrier spacing of the uplink bandwidth part, or a combination thereof.

Aspect 28: The method of any of aspects 15 through 27, wherein a subband of the plurality of subbands comprises a predefined number of resource blocks.

Aspect 29: An apparatus for wireless communication at a UE, comprising a processor; memory coupled with the processor; and instructions stored in the memory and executable by the processor to cause the apparatus to perform a method of any of aspects 1 through 14.

Aspect 30: An apparatus for wireless communication at a UE, comprising at least one means for performing a method of any of aspects 1 through 14.

Aspect 31: A non-transitory computer-readable medium storing code for wireless communication at a UE, the code comprising instructions executable by a processor to perform a method of any of aspects 1 through 14.

Aspect 32: An apparatus for wireless communication at a network entity, comprising a processor; memory coupled with the processor; and instructions stored in the memory and executable by the processor to cause the apparatus to perform a method of any of aspects 15 through 28.

Aspect 33: An apparatus for wireless communication at a network entity, comprising at least one means for performing a method of any of aspects 15 through 28.

Aspect 34: A non-transitory computer-readable medium storing code for wireless communication at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive an indication of an uplink bandwidth part associated with a random access procedure, the uplink bandwidth part comprising a plurality of subbands corresponding to a plurality of random access occasions;
select a random access occasion from the plurality of random access occasions based at least in part on an offset parameter; and
transmit an uplink random access channel message at the random access occasion of the plurality of random access occasions.

2. The apparatus of claim 1, wherein the instructions are further executable by the processor to cause the apparatus to:
receive a system information message comprising the offset parameter; and
determine the offset parameter based at least in part on receiving the system information message.

3. The apparatus of claim 1, wherein the instructions are further executable by the processor to cause the apparatus to:
identify a subband of the plurality of subbands overlapping in frequency with the random access occasion of the plurality of random access occasions; and
transmit an initial subset of a physical uplink shared channel in a first resource block of the subband of the plurality of subbands.

4. The apparatus of claim 1, wherein the instructions are further executable by the processor to cause the apparatus to:
transmit a second uplink random access channel message in a subband of the plurality of subbands overlapping in frequency with the random access occasion of the plurality of random access occasions, wherein the uplink random access channel message comprises a physical random access channel preamble and the second uplink random access channel message comprises a physical uplink shared channel.

5. The apparatus of claim 4, wherein the instructions to transmit the second uplink random access channel message in the subband of the plurality of subbands are executable by the processor to cause the apparatus to:
receive, from a network entity, a mapping between the plurality of random access occasions and the plurality of subbands; and
select the subband of the plurality of subbands for transmitting the second uplink random access channel message based at least in part on the mapping.

6. The apparatus of claim 5, wherein the mapping comprises at least one of a one to one mapping between the plurality of random access occasions and the plurality of subbands, a mapping between the random access occasion of the plurality of random access occasions and the plurality of subbands, a mapping between the subband of the plurality of subbands and the plurality of random access occasions, or a combination thereof.

7. The apparatus of claim 1, wherein the instructions to transmit the uplink random access channel message are further executable by the processor to cause the apparatus to:
transmit one or more uplink random access message instances at one or more random access occasions of the plurality of random access occasions, wherein each of the one or more uplink random access message instances corresponding to a first message of the random access procedure are transmitted on a different random access occasion, wherein a same preamble is repeated in each random access message instance.

8. The apparatus of claim 7, wherein the one or more random access occasions of the plurality of random access occasions are different in time, frequency, or a combination thereof.

9. The apparatus of claim 7, wherein the instructions are further executable by the processor to cause the apparatus to:
transmit a physical uplink shared message in a subband of the plurality of subbands overlapping in frequency with the random access occasion of the one or more random access occasions, wherein the random access occasion comprises the random access occasion at which a last uplink random access message instance of the one or more uplink random access message instances was transmitted, wherein the one or more uplink random access message instances correspond to a first message of the random access procedure.

10. The apparatus of claim 7, wherein the instructions are further executable by the processor to cause the apparatus to:
transmit a physical uplink shared message in a subband of the plurality of subbands overlapping in frequency with the random access occasion of the one or more random access occasions, wherein the random access occasion comprises the random access occasion at which a first uplink random access message instance corresponding to the first message of the random access procedure was transmitted.

11. The apparatus of claim 1, wherein the instructions are further executable by the processor to cause the apparatus to:
transmit a second uplink random access channel message in a subband of the plurality of subbands overlapping in frequency with the random access occasion of the plurality of random access occasions, wherein the uplink random access channel message comprises a physical random access channel preamble and the second uplink random access channel message comprises a physical uplink control channel.

12. The apparatus of claim 1, wherein the offset parameter indicates at least one of a same offset for each subband of the plurality of subbands, a different offset for each subband of the plurality of subbands, or a combination thereof.

13. The apparatus of claim 1, wherein the offset parameter is based at least in part on at least one of a maximum bandwidth of the UE, an initial physical resource block of the uplink bandwidth part, a sub-carrier spacing of the uplink bandwidth part, or a combination thereof.

14. The apparatus of claim 1, wherein a subband of the plurality of subbands comprises a predefined number of resource blocks.

15. An apparatus for wireless communication at a network entity, comprising:
a processor;
memory coupled with the processor; and
instructions stored in the memory and executable by the processor to cause the apparatus to:
output an indication of an uplink bandwidth part associated with a random access procedure, the uplink bandwidth part comprising a plurality of subbands corresponding to a plurality of random access occasions; and
obtain an uplink random access channel message at a random access occasion of the plurality of random access occasions, wherein the random access occasion of the plurality of random access occasions based at least in part on an offset parameter.

16. The apparatus of claim 15, wherein the instructions are further executable by the processor to cause the apparatus to:
output a system information message comprising the offset parameter.

17. The apparatus of claim 15, wherein the instructions are further executable by the processor to cause the apparatus to:
identify a subband of the plurality of subbands overlapping in frequency with the random access occasion of the plurality of random access occasions; and
obtain an initial subset of a physical uplink shared channel in a first resource block of the subband of the plurality of subbands.

18. The apparatus of claim 15, wherein the instructions are further executable by the processor to cause the apparatus to:
obtain a second uplink random access channel message in a subband of the plurality of subbands overlapping in frequency with the random access occasion of the plurality of random access occasions, wherein the uplink random access channel message comprises a physical random access channel preamble and the second uplink random access channel message comprises a physical uplink shared channel.

19. The apparatus of claim 18, wherein the instructions to obtain the second uplink random access channel message in the subband of the plurality of subbands are executable by the processor to cause the apparatus to:
output a mapping between the plurality of random access occasions and the plurality of subbands, wherein the subband of the plurality of subbands for transmitting the second uplink random access channel message is selected based at least in part on the mapping.

20. The apparatus of claim 19, wherein the mapping comprises at least one of a one to one mapping between the plurality of random access occasions and the plurality of subbands, a mapping between the random access occasion of the plurality of random access occasions and the plurality of subbands, a mapping between the subband of the plurality of subbands and the plurality of random access occasions, or a combination thereof.

21. The apparatus of claim 15, wherein the instructions to obtain the uplink random access channel message are further executable by the processor to cause the apparatus to:
obtain one or more uplink random access message instances at one or more random access occasions of the plurality of random access occasions, wherein each of the one or more uplink random access message instances corresponding to a first message of the random access procedure are transmitted on a different random access occasion, wherein a same preamble is repeated in each random access message instance.

22. The apparatus of claim 21, wherein the one or more random access occasions of the plurality of random access occasions are different in time, frequency, or a combination thereof.

23. The apparatus of claim 21, wherein the instructions are further executable by the processor to cause the apparatus to:
obtain a physical uplink shared message in a subband of the plurality of subbands overlapping in frequency with the random access occasion of the one or more random access occasions, wherein the random access occasion comprises the random access occasion at which a last uplink random access message instance of the one or more uplink random access instances was received, wherein the one or more uplink random access message instances correspond to a first message of the random access procedure.

24. The apparatus of claim 21, wherein the instructions are further executable by the processor to cause the apparatus to:
obtain a physical uplink shared message in a subband of the plurality of subbands overlapping in frequency with the random access occasion of the one or more random access occasions, wherein the random access occasion comprises the random access occasion at which a first uplink random access message instance corresponding to the first message of the random access procedure was transmitted.

25. The apparatus of claim 15, wherein the instructions are further executable by the processor to cause the apparatus to:
obtain a second uplink random access channel message in a subband of the plurality of subbands overlapping in frequency with the random access occasion of the plurality of random access occasions, wherein the uplink random access channel message comprises a physical random access channel preamble and the second uplink random access channel message comprises a physical uplink control channel.

26. The apparatus of claim 15, wherein the offset parameter indicates at least one of a same offset for each subband of the plurality of subbands, a different offset for each subband of the plurality of subbands, or a combination thereof.

27. The apparatus of claim 15, wherein the offset parameter is based at least in part on at least one of a maximum bandwidth of the UE, an initial physical resource block of the uplink bandwidth part, a sub-carrier spacing of the uplink bandwidth part, or a combination thereof.

28. The apparatus of claim 15, wherein a subband of the plurality of subbands comprises a predefined number of resource blocks.

29. A method for wireless communication at a user equipment (UE), comprising:
receiving an indication of an uplink bandwidth part associated with a random access procedure, the uplink bandwidth part comprising a plurality of subbands corresponding to a plurality of random access occasions;
selecting a random access occasion from the plurality of random access occasions based at least in part on an offset parameter; and
transmitting an uplink random access channel message at the random access occasion of the plurality of random access occasions.

30. A method for wireless communication at a network entity, comprising:
outputting an indication of an uplink bandwidth part associated with a random access procedure, the uplink bandwidth part comprising a plurality of subbands corresponding to a plurality of random access occasions; and
obtaining an uplink random access channel message at a random access occasion of the plurality of random access occasions, wherein the random access occasion of the plurality of random access occasions based at least in part on an offset parameter.
